(19) United States
(12) Patent Application Publication
(10) Pub. No.: US 2023/0102968 A1
(43) Pub. Date: Mar. 30, 2023

(54) Selective Predator Incapacitation Device & Methods (SPID)

(71) Applicant: Paul J. Weber, Nendaz (CH)

(72) Inventor: Paul J. Weber, Nendaz (CH)

(21) Appl. No.: 17/449,088

(22) Filed: Sep. 27, 2021

(51) Int. Cl. A01M 23/36; G06K 9/00; H04W 4/38; A01M 23/16

(52) U.S. Cl. CPC A01M 23/36; G06K 9/00362; H04W 4/38; A01M 23/16

(57) ABSTRACT

Selective predator incapacitation devices, along with related methods and systems. In some embodiments, the device may comprise an enclosure comprising an exterior opening. A gate may be positioned within the exterior opening, which gate may be selectively openable to allow for receipt of a head of a predator therethrough. Some embodiments may incorporate facial recognition or other anatomical feature recognition to ensure that only the desired predator, or only mostly the desired predator, is captured and/or incapacitated by the device. The device may further comprise means for incapacitating the predator.

Disclosed herein are various inventive methods and assemblies for selective predator incapacitation devices, along with related methods and systems. In some embodiments, the device may comprise an enclosure comprising an exterior opening. A gate may be positioned within the exterior opening, which gate may be selectively openable to allow for receipt of a head of a predator therethrough. Some embodiments may incorporate facial recognition or other anatomical feature recognition to ensure that only the desired predator, or only mostly the desired predator, is captured and/or incapacitated by the device. The device may further comprise means for incapacitating the predator. The assembly may lend itself to aiding in resetting the natural ecologic balance.

Every year, Australian feral cats kill 1.4 billion native animals, around the same number that died in the catastrophic 2019-20 bushfires wherein 70,000 square miles burned. The Australian Parliament reported that Australia's 3-5 million feral cats were primary drivers in mammal extinctions. Cats arrived with the first European settlers and occupy 99.9% of the Australian continent. Each individual Australia feral cat may kill 390 mammals, 225 reptiles and 130 birds annually. New Zealand has similar native species loss problems. In the USA alone, cats kill up to 22 billion, mostly native, mammals annually. (source: https:www.smithsonianmag.com/science-nature/australias-cats-kill-two-billion-animals-annually-1809772350/)

Australian feral red foxes cover 75% of the continent numbering about 7 million and are also a major hazard to native wildlife (source: https://agriculture.vic.gov.au/biosecurity/pest-animals/priority-pest-animals/red-fox.) Foxes were allegedly introduced for the purpose of the traditional English blood ‘sport’ of fox hunting.

Ferrets in Australia are also aggressive predators that may threaten biodiversity of a wide range of native birds, mammals, marsupials, reptiles and frogs. The assembly may be adjusted to selectively control these predators as well.

Current measures of predator control include at least poisoned baits, traps, snares, and hunting. Some of these measures are indiscriminate and do not always disadvantage the intended predator. Others are costly and are not able to significantly address the relatively large numbers of potential predators discussed above For example, aerially dropping thousands and thousands of poisoned sausages en masse may have unintended consequences on unstudied animals. Additionally, robots that estimate sizes or shapes of animal targets to spray with ‘lick-able’ poison may not have the needed discriminatory accuracy to prevent unintended consequences.

Current technology may enable a system that can discriminate its intended predator(s), efficiently and possibly humanely cull, sterilize or disable them via an offering of a variety of methods on a larger scale than current measures. For example, the distant operating senses (sight and hearing) of a predator may be altered to interfere with hunting abilities. The current application discusses control measures that are principally targeted to the head and neck region of a predator.

By limiting entrance or action to head characteristics, facial recognition software may receive the most discerning/discriminating data, that of the face and its prime components eyes, nose, ears, mouth and their respective dimensions, angles of orientation, component parts and distances between components. Absolute measurements or ratios thereof may be useful.

Useful measurements may exclude native species from the device, for example, in Australia Quolls or so called ‘Australian Native Cats’ of the genus Dasyurus are marsupials not at all related to true cats deriving their misnomer from their cat-like-looks and predatory behaviors. Their long snouts help photographically distinguish them from true cats to restrict quolls from the SPID system.

The Australian Dingo (dog) is considered native to Australia possibly arriving over 8,300 years ago. The Australian Protection Act 1994 and the Wildlife Act 1975 differ on the culling or protection of the dingo, thus the SPID may be programmed or reprogrammed to include or exclude animals as a result of changing government decrees or needs. This may apply to myriad of animals.

The following SPID system descriptions contains a number of disabling technologies, not all of which may be necessary to obtain the desired results. Perhaps as few as one disabling technology is necessary in a particular customized unit to derive a probability of a given result for the end user, thus lowering costs, reducing size or energy requirements.

Starlink Satellite communications may facilitate the function of some embodiments of SPHC devices. SpaceX has submitted applications to the Federal Network Agency (BNetzA) for frequency allocation of Ka-band at 27.5 . . . 29.1 GHz (uplink) and 17.3 . . . 18.6 GHz (downlink). The user access is operated at 10.95 . . . 12.7 GHz (downlink) and 14.0 . . . 14.5 GHz (uplink) in the Ku band. The maximum radiated power of the user terminals in the Ku band may be 38 dBW. With an antenna gain of 34 dBi, this corresponds to a transmission power of 2.5 W. Small transmissions may be achievable for proper functioning of the device using contemplated communication satellite systems. Amazon is contemplating launching such systems as well. Eventually the globe may be swarmed with tens of thousands of such satellites facilitating communication into the remote Australian Outback where SPHC devices can benefit. Starlink Satellites alone have been proposed in the range of over 30,000.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1a is a perspective view of the SPID,

FIG. 1b is a top plan view of the SPID.

FIG. 1c is a perspective view of the SPID showing the interior thereof.

FIG. 1d is a side elevation view of the SPID.

FIG. 2 is a top plan view of the interior of an enclosure of the system with the roof removed to illustrate various examples of internal components for attracting, capturing, disabling, sterilizing, and/or otherwise preventing a predator from surviving and/or reproducing.

FIG. 3a is a front elevation view of the front wall of the SPID.

FIG. 3b is a front view of the gate of the SPID of FIG, 3a.

FIG. 4a is a front view of the outermost side of the first interior wall.

FIG. 4b is a cross-sectional view taken along line 4b-4b in FIG. 4a.

FIG. 4c depicts the elements positioned within the first interior wall of a SPID according to some embodiments.

FIG. 4d is an expanded front view of some exemplary elements for tightening and severing a predator collar line within the first interior wall.

FIG. 5a is a front elevation view of elements positioned within or otherwise adjacent to the second interior wall according to some embodiments.

FIG. 5b is a cross-sectional view taken through line 5b-5b in FIG. 5a.

FIG. 6a is a side view of a food source reservoir and large food source distribution device/means according to some embodiments.

FIG. 6b is a front elevation view of the food source reservoir and large food source distribution device/means of FIG, 6a.

FIG. 7a is a transparent side elevation view of an eyeball probe device/means according to some embodiments.

FIG. 7b is a transparent side elevation view of an injection needle device/means according to some embodiments,

FIG. 7c is a transparent side elevation view of a jaw breaker device/means according to some embodiments.

FIG. 8a is a cross-sectional view of a liquid atomizer with reservoir according to some embodiments.

FIG. 8b is a cross-sectional view of a powder sprayer with reservoir according to some embodiments.

FIG. 9 is a cross-sectional view of feature for repositioning the enclosure in the event that it tips over.

FIG. 10a is a side elevation view of a 6 wheeled mobility embodiment.

FIG. 10b is a front view of a 6 wheeled mobility embodiment.

FIG. 11 is a side view of an extraterrestrial style rover hinged chassis mobility embodiment.

FIG. 12 is a front elevation view of an assembly/system to allow an enclosure to be either manually or remotely mounted into the ground.

FIG. 13a is a front elevation view of an assembled iris door/diaphragm assembly/system.

FIG. 13b is a front elevation view of an opposing ring half of iris door/diaphragm assembly/system.

FIG. 13c is a front elevation view of an opposing ring half of iris door/diaphragm assembly/system with a lever.

FIG. 13d is a front elevation view of a single vane of an iris door/diaphragm assembly/system.

FIG. 14a is a front elevation view of elements positioned within or otherwise adjacent to an outer wall that was the second interior wall according to some embodiments after the removal of intervening walls.

FIG. 14b is a cross-sectional view taken through line 14b-14b in FIG. 14a.

FIG. 15 depicts a flowchart example of the use of potential predator facial recognition software to restrict entry to the SPID system.

FIG. 16a is a further flowchart example of the use of potential predator facial recognition software to restrict entry to the SPID system.

FIG. 16b is a table showing a data set which depicts predicted versus true instances of a plurality of animal classifications for a model trained on a given number of images but tested on separate/different images showing accurate and inaccurate predictions.

FIG. 16c is a table showing a data set which depicts predicted versus true instances of a plurality of animal classifications for a model trained on a given number of images but tested on separate/different images showing accurate and inaccurate predictions.

FIG. 16d is a table showing a data set which depicts predicted versus true instances of a plurality of animal classifications for a model trained on a given number of images but tested on separate/different images showing accurate and inaccurate predictions.

FIG. 16e is a table showing a data set which depicts predicted versus true instances of a plurality of animal classifications for a model trained on a given number of images but tested on separate/different images showing accurate and inaccurate predictions.

FIG. 17 depicts another flowchart example of the use of potential predator facial recognition software to restrict entry to the SPID system.

FIG. 18 depicts a flowchart example of the use of communications equipment on a potential SPID system to improve data for use in future predator processing, such as to transmit data from animals whose entry was restricted by computational probability for offsite processing.

### DETAILED DESCRIPTION

Further details regarding various embodiments will now be provided with reference to the drawings.

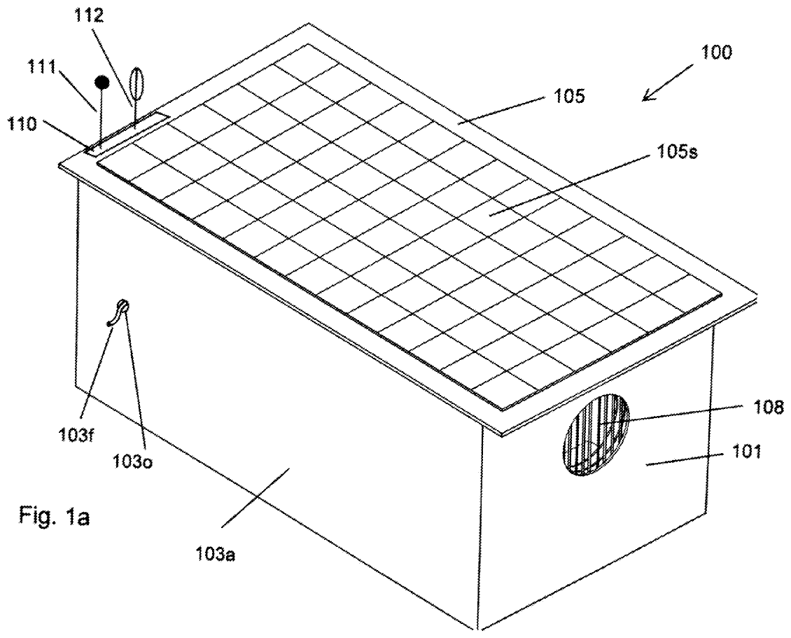

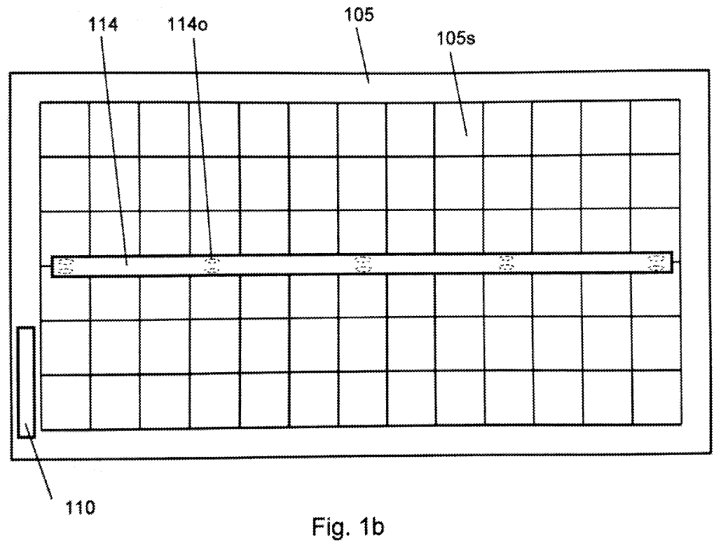

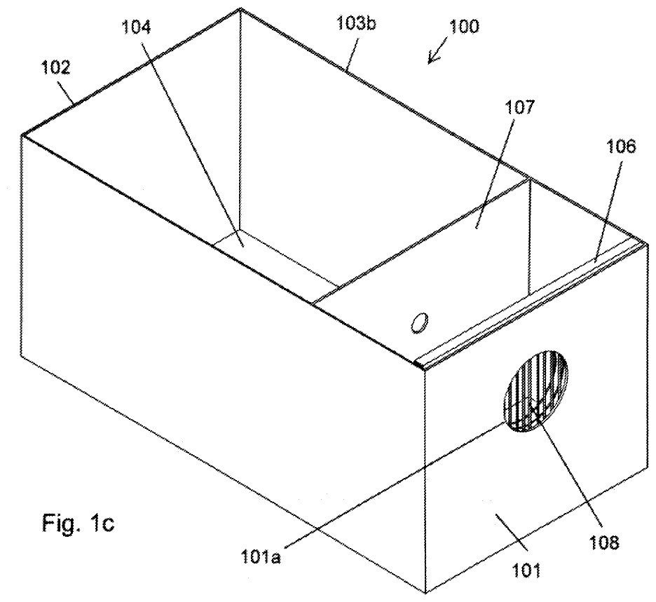

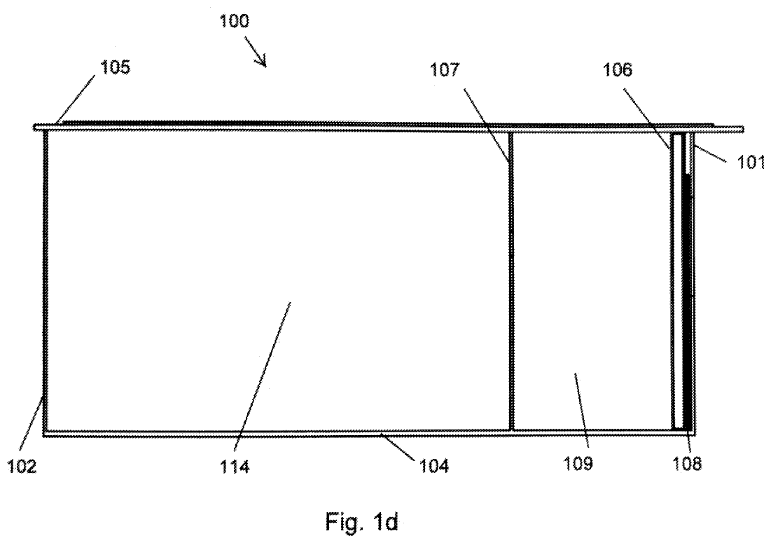

FIG. 1a depicts a perspective view of a system/assembly 100 comprises front outer wall 101, side wall 103a and roof 105. Roof 105 may further comprise solar cells 105s and an exit point 110 for antennas 111 and/or other wireless transmitters/receivers 112. Roof 105 may comprise one or more members that may be hinged for easier internal access in a variety of shapes that may include flat-style, gabled, simple Skillion, barrel vaulted among others. Moveable gate 108 may be partially viewed behind front outer wall 101. Not seen in this view are rear wall 102, side wall 103b and floor 104. In some embodiments, a secondary mental-relaxation food source 103f may emerge from opening 103o and be presented as a long strand of flexible meat that may be stored on a spool or a coil shape to save space and aid in distribution through a small sidewall orifice via, for example, pinch rollers. In some embodiments, the secondary mental-relaxation food source 103f strand may be 3 mm wide and range in lengths up to a meter. In some embodiments, the secondary mental-relaxation food source 103f strand may be meted out at shorter lengths of perhaps 1 cm to conserve supply after an adjacent camera or infrared detector signals the CPU to actuate motorized pinch rollers with rasps to move the food toward the opening. The secondary mental-relaxation food source may contain a sedative/hypnotic drug such as a benzodiazopene or diazepam, zolpidem, suvorexant, butabarbital, quazepam, flurazepam, triazolam and the like. If the concentration of the drug is high enough in the meat then perhaps only 1 cm of the meaty secondary mental-relaxation food source need be meted out per predator thus saving on this resource. Catnip or other attractants may also lace the meat strand. The benefits of the secondary mental-relaxation food source may be multiple, not only to give a pleasurable treat/sample to lower the hungry predators guard, but much like a nightclub to a human, to provide a drug that may lower inhibitions allowing a crafty predator to lower its guard and engage the remainder of the Selective Predator Head Control Device with less caution, Cheers! Here, here!

FIG. 1b depicts a top view of roof 105 and solar cells 105s and exit point 110 for antennas and other wireless transmitters/receivers. In some embodiments, tube/conduit 114 may be mounted exterior to the roof and may comprise one or more gas/fluid openings 114o to allow passage of compressed gas or cleaning fluids. Conduit 114 may be connected to an internal hose. In some embodiments, conduit 114 may be connected to an internal hose which is in connection to a gas tank capable of storing a gas, such as air, at high pressure; the connection may be indirect through a gas distributor means (possibly similar to that manufactured by SMC Pneumatics of 10100 SMC Boulevard, Noblesville, Ind. 46060). In arid environments such as the Australian Outback, dust may coat solar cells, thereby negatively impacting performance. An algorithm in a CPU incorporated into the assembly 100 may detect low battery charge and/or low solar cell output. A data storage element, such as a flash memory element or hard drive, may be communicatively coupled with the CPU to allow for storage of such data if desired. The CPU may then direct the pressurized air distributor to release jets of compressed air gas through openings 114o thus cleaning the solar cells. A tilted roof 105 may also aid in cleaning if rain carries dust and debris downward at an angle without pooling, drying out and leaving an obscuring residue. Communications antennas may download weather information or instructions alerting the PU not to wastefully emit compressed gas during a rainstorm.

FIG. 1c depicts a perspective view of assembly 100 with the roof removed showing some possible permutations of internal partitions which may include first interior wall 106 and second interior wall 107. First interior wall 106 and second interior wall 107 may vary in relative locations and thicknesses. Moveable gate 108 may slide within an opening 101a between front outer wall 101 and first interior wall 106 to restrict entry to various recognized predators. System/assembly 100 further comprises rear wall 102, side wall 103b and floor 104. In some embodiments, moveable gate 108 may comprise an actuator, such as an air piston, a cable drive, a motor, and/or other elements that may be used to open and close gate 108. The actuator may be communicatively coupled with the CPU and/or one or more sensors to allow for selectively opening and/or closing gate 108 upon detection of a desired predator, such as a cat, and/or upon detection of the predator having removed its head from the adjacent opening of the front outer wall hole/aperture 101a located in front outer wall 101. In some embodiments, a flexible shaft and/or cable assembly, such as a Bowden cable or push-pull cable, may be used to transmit motion from a motor to one or more portions of assembly 100, such as gate 108. Such actuators may be coupled to or used in place of various mechanical elements, such as, for example, universal joints, gears, sprockets and chains, and/or belts and pulleys. Opening 101a may be sized to restrict various entrants, for example fox skulls often measure 130-165 mm thus restricting the opening to 120 mm may restrict out foxes while allowing cats & ferrets. Later in this document, the use of an iris diaphragm may allow for more specific real time active predator selectivity and restriction. FIG. 1d depicts a side view of assembly 100 with a sidewall removed showing some possible permutations of internal partitions which may include first interior wall 106 and second interior wall 107, Moveable gate 108 may be moveably positioned within an opening 101a formed between front outer wall 101 and first interior wall 106, Note that a predator head may be operated upon in the space between first interior wall 106 and second interior wall 107. The head-operating-space 109 lies between first interior wall 106 and second interior wall 107. Also note the instrumentation/storage space 114 between roof 105, floor 104, rear wall 102 and the second interior wall 107 may accommodate various power sources, power storage sources, gas & fluid reservoirs, electronics, CPU's, distributors, servos, food sources, attractant reservoirs and chemicals as may necessary to achieve the goals of desired predator control. Upon meeting the preprogrammed facial recognition requirements, a CPU and an associated motor or other actuator, such as a servo motor, may be used to move moveable gate 108 to allow the selected predator's head entrance past front outer wall 101 and past first interior wall 106 into the head-operating-space 109 between first interior wall 106 and second interior wall 107. Dimensions of the assemble may be about 65 cm length×30 cm height (not including roof & communications)×35 cm width although model customization sizes may vary according to need. Roof style, overhang, roving/mobility undercarriage, wheels, and other possible protrusions are not included in the aforementioned dimensions.

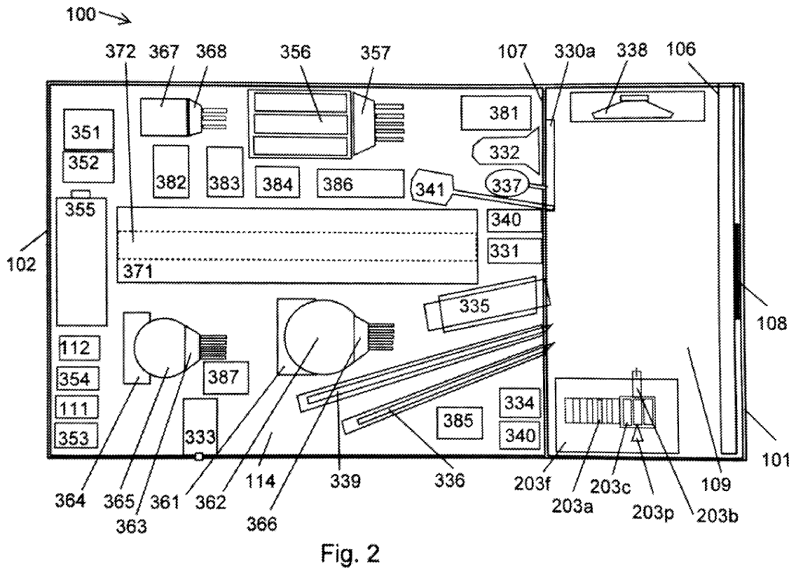

FIG. 2 depicts a top view of assembly 100 with the roof removed showing some possible permutations of internal partitions which may include first interior wall 106 and second interior wall 107. Moveable gate 108 may slide between front outer wall 101 and first interior wall 106 to selectively restrict entry to various recognized predators.

In some embodiments, possible permutations may exist of internal partitions and/or instrument/device locations within the instrumentation/storage space 114 between rear wall 102 and the second interior wall 107. Lying adjacent or within second interior wall 107 may be camera 331, one or more attractants, such as an attractant speaker 332, an attractant food presentation device/means 333 (which, in some embodiments, may additionally be used to sedate, relax, and/or reduce the inhibitions of the predator), a reservoir and/or delivery system for airborne/volatile attractant(s) 381, an attractant vapor emitter device/means 334, and/or a visual attractant 330a (that might for example show a predators nether regions or ‘kitty porn’), such as a video or image on a LED, OLED or other screen and/or system for projecting images. In some embodiments, visual attractant 330a may serve other purposes, for example an OLED may be brightened to aid in facial or anatomical landmark (eye, nose, ear) recognition by brightening, or of intensity so the predator can see an object such as a food source in an enclosed area or to be dimmed such that a pupa dilates allowing a LASER source to affect the retina.

One or more injurious elements may also be positioned in instrumentation/storage space 114 and/or head-operating-space 109, which may be configured to incapacitate the predator, such as, for example, sterilize, terminate, injure, sicken, and/or render the predator unable or less able to hunt. Each of these elements, as disclosed herein, should be considered an example of a means for incapacitating a predator, or an “injurious means.” In some embodiments, the one or more injurious elements may be specifically configured to ultimately terminate the predator, but preferably not immediately, which may result in the device/system being unusable or less useful in incapacitating or terminating additional predators. Examples of such injurious elements include, for example, jaw breaker device/means 335, eyeball probe device/means 336, cornea toxic fluid/vapor emission device/means 337, eardrum-percussion device/means 338, injection needle device/means 339, lung-bound-gas emission device/means 340 and/or eye damaging LASER device/means 341, Depending upon the thickness and/or composition of the second interior wall 107, any of the aforementioned items may also be partially or completely located in instrumentation/storage space 114. Instrumentation/storage space 114 may further comprise locations for CPU 351, data storage element 352, battery 353, supercapacitor 354, servo unit 355, electric motor(s) 356, electric motor rotation distributor 357, air compressor/pump 361, compressed gas storage tank 362, compressed gas distributor 363, vacuum pump 364, vacuum tank 365, vacuum distributor 366, hydraulic reservoir 367, hydraulic distributor 368, large food source reservoir 371, large food source distribution device/means 372, reservoir for eye-toxic chemical(s) 382, reservoir for ear-toxic chemical(s) 383, reservoir for lung-toxic chemical(s) 384, reservoir for injectable implant(s) 385, reservoir for combustible gas-fluid 386, reservoir for small/secondary mental-relaxation food source 387. It should be understood that, although each of these elements is shown as being present in system/assembly 100, typically only a desired subset of these elements would be used in a particular system/assembly.

In some embodiments, reservoirs may comprise plastics, glass, ceramics, stainless steel, and/or alloys or other materials that are relatively inert to the contemplated contained materials.

In some embodiments, the large food source reservoir 371 may contain poisons such as sodium fluoroacetate, bromethalin, anticoagulants (brodifacoum, bromadiolone, difethiolone), zinc phosphide, cholecalciferol, arsenic, cyanide, and Coumadin. Endocrine Disrupting Chemicals may be included to cause sterility. Any one or more of these poisons and/or disrupters may be delivered in a variety of foods that may be attractive to the object predator, such as various meats and/or synthetic foods and/or food attractants.

In some embodiments, the reservoir for attractant(s) 381 may contain catnip (Nepeta cataria), Tartarian honeysuckle (Lonicera tatarica), valerian (Valeriana officinalis), and silver vine (Actinidia polygama), cat pheromones including 3-mercapto-3-methylbutan-1-ol (MMB) and their precursors or degradation products, iridoid terpenes, feline facial pheromones (produced from glands located around the mouth, chin, forehead and cheeks) as well as pheromones from the lower back, tail and paws.

In some embodiments, the reservoir for eye-toxic chemical(s) 382 may contain sulfuric acid, acetic acid, hydrochloric acid, sulfurous acid, hydrofluoric acid, ammonia, lye (sodium hydroxide), lime (calcium-containing inorganic minerals composed primarily of oxides, and hydroxide, usually calcium oxide and/or calcium hydroxide), potassium hydroxide, and/or magnesium hydroxide.

In some embodiments, the reservoir for ear-toxic chemical(s) 383 may contain acetic acid (especially>5%), chlorhexidine gluconate, aminoglycosides (such as streptomycin, kanamycin, neomycin, gentamicin, tobramycin, amikacin, and netilmicin), iodine, carbon disulfide, benzene, styrene, trichloroethylene, toluene, and/or xylene.

In some embodiments, the reservoir for lung-toxic chemical(s) 384 may contain acrolein, ammonia, ethylene oxide, formaldehyde, hydrogen chloride, hydrogen fluoride, methyl bromide, sodium azide, sulfur dioxide, chlorine, cadmium fume, mercury fume, mustard gas, nickel carbonyl, oxides of nitrogen, ozone, phosgene and/or the like.

In some embodiments, the reservoir for injectable implant(s) 385 may contain antifertility vaccines and drugs. These may include GonaCon, a single-shot, multiyear vaccine that stimulates the production of antibodies that bind to GnRH, thus inhibiting the production of sex hormones, such as estrogen, progesterone, and testosterone. Long-acting or depot preparations of progestins such as medroxyprogesterone acetate may be used in some embodiments. Norethisterone oenanthate (NET-OEN), norethindrone enanthate (NET-EN) may also be useful. High doses of steroid based contraceptives (which may include long-acting esters of known steroids (norethisterone and levonorgestrel) in conjunction with release delay polymer systems may be used in some embodiments, Bisphenol-A (BPA) may be added to induce male sterility. One or more drugs may be injected into a cat of unknown sex so as to counter either male or female reproductivity.

In some embodiments, the reservoir for combustible gas-fluid 386 may contain acetylene, butane, ethylene, methane, propane, propylene, hydrogen, chlorine trifluoriden and/or the like. Volatile combustible liquids such as hexane, octane and/or the like may have a gas phase that is combustible as well. Other contemplated embodiments may contain napalm (naphthalene/palmitate/gasoline).

In some embodiments, the reservoir for small/secondary mental-relaxation food source 387 may contain sedatives, hypnotics, and/or tranquilizers such as: acepromazine, fluoxetine, paroxetine, sertraline, clomipramine, buspirone, alprazolam, lorazepam, oxazepam, trazodone, gabapentin and/or the like. Drowsy antihistamines (1st-generation antihistamines such as chlorphenamine, hydroxyzine, promethazine and/or the like may be used alone or in combination. Psychedelics (serotonergic hallucinogens) may be helpful and other psychoactive substances that alter perception, mood and various cognitive processes, Clonazepam, chlordiazepoxide, flurazepam, quazepam, temazepam, trazodone, triazolam eszopiclone, zaleplon, zolpidem, and zopiclone may be useful also Barbiturates including, but not limited to: amobarbital, butabarbital, butalbital, mephobarbital, methohexital, pentobarbital, phenobarbital, primidone, secobarbital, thiopental, secobarbital may be useful as well. In some implementations psychedelics including, but not limited to: alkylated tryptamines, lysergamides, alkoxylated phenethylamines, alpha-methyl-phenethylamines, cyclopropylethynylated benzoxazines, entactogens, and cannabinoids may be useful as well.

In some contemplated embodiments, the eardrum-percussion device/means 338 may comprise a compressed air-driven siren (Scientific Applications & Research Associates, Inc., Cypress, Calif.); a combustion-driven siren (the dismounted battle space battlefield laboratory) (Scientific Applications & Research Associates, Inc); an impulsive acoustic device (the sequential arc discharge acoustic generator) (U.S. Army Research Laboratory, Adelphi, Md.), and/or a complex waveform generator (the Gayl Blaster, U.S. Army Armament Research, Development & Engineering Center, Picatinny, N.J.); GGO Air Horn 12 volt, 150 decibel

In some embodiments, other injurious elements may also be positioned in head-operating-space 109, which may be configured to hinder hearing. Although such elements may be bilateral, it is possible damaging one ear may incapacitate stereo hearing necessary to find prey and may therefore be sufficient. Firearm cylinder 203c and firing pin 203p potions may he within magazine and fixation area, such as a box 203f, along with ammunition belt 203a. In some embodiments, ammunition belt 203a may be used alone in place of firearm cylinder 203c, or together therewith. Eardrum rupture may occur at >160 dB even with blank rounds at dose range. Some blank rounds such as 22 long, 38+p & 44 magnums may enhance the acoustic waves. The firing pin may be a portion of a gun as may be the case with respect to barrel 203b. Barrel 203b may enhance acoustic wave progression toward a predator's external ear and thus eardrum. In some embodiments, bang-stick and or fireworks/firecrackers may be used and the system modified to achieve eardrum rupture.

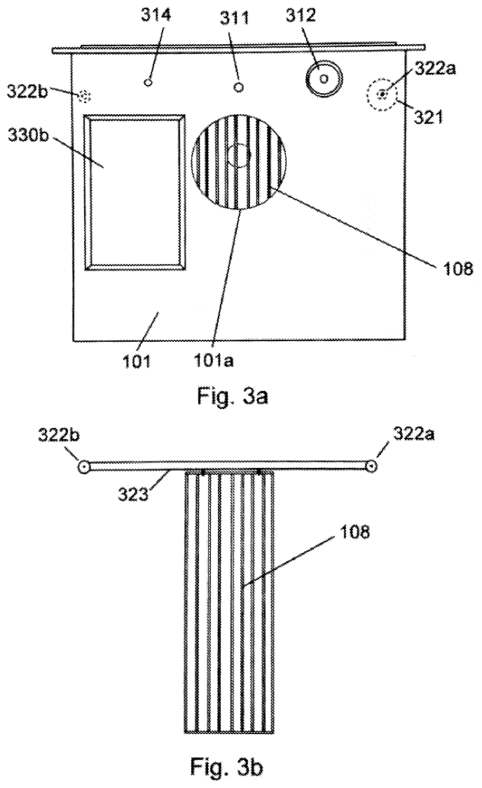

FIG. 3a depicts a front view of the front outer wall 101 which may comprise hole/aperture 101a, camera 311, speaker 312 and vapor emitter 314. Seen occupying the area just posterior to hole/aperture 101a is a portion of moveable gate 108. Speaker 312 may emit sound recordings, possibly alternating, of male or female cats or their prey to attract cats, if cats are the target predator. Vapor emitter 314 may emit vapors, mists or streams of actual scents or those mimicking male or female predators or their prey to attract a particular predator; the smell of a food source may also, or alternatively, be emitted. Vapor emitter 314 may also emit the smell of catnip, an alleged attractant of many cats. Visual attractant 330b may comprise a video or image on a LED, OLED or other screen and/or system for projecting images. Such video or still images may comprise food sources, other cats or other target predators (whole or in part), kitty porn, toys, etc. In some embodiments, visual attractant 330b may serve other purposes, for example, an OLED may be brightened to aid in facial or anatomical landmark (eye, nose, ear) recognition by brightening, or of intensity so the predator can see an object such as a food source in an enclosed area or to be dimmed such that a pupil dilates allowing a LASER source to affect the retina.

One or more CCD cameras 311 may be mounted on or within front outer wall 101 to determine via facial recognition whether moveable gate will open allowing the predator's head access through hole/aperture 101a. In alternative embodiments, CMOS sensors may be used. Facial recognition programs have existed for various animals including cats since about 2014 and accuracy has improved much since. In some contemplated embodiments, multiple cameras may be present as on smart phones which may allow improved picture quality and optical zoom functionality. The cameras may have varying lenses that may provide wide angle imaging or zoomed-in imaging. Additional cameras may be used, including but not limited to infrared, and black/white for increased light sensitivity. Camera images may be processed for the CPU and software to identify a potential predator and take a desired responsive action, such as emitting an attractant vapor/scent, displaying an arousing or pleasurable image/video, presenting attractant food, or making an arousing, pleasurable, mating or prey-related sound. Cameras may be used in roving or moveable models to detect terrain for programmable or remote maneuvering via broadcast signaling (perhaps via satellite link in the Australian Outback, for example).

Head size may be restricted by altering the size of hole/aperture 101a, which in this particular embodiment is about 10 cm, about the size of a feral cat. In some embodiments, electric motor 321 may turn pulley 322a, as best seen in FIG. 3b, which may actuate a drive element (such as a rope, cable, belt, or chain) directly or indirectly. Pulley 322a may be coupled with gate 108 that passes through contralateral pulley 322b to allow multilateral movement of gate 108. Pulleys 322a and 322b are shown in dashed lines in FIG. 3a to indicate a possible location behind outer front wall 101. In other contemplated embodiments, a motor, located in another compartment, may actuate a flexible shaft and/or cable assembly, such as a Bowden cable or push-pull cable, to transmit motion from a motor to the gate, with or without interposed pulleys or cogs.

In other contemplated embodiments, instead of providing a gate adjacent the hole/aperture, an iris door may be used, such as that seen in U.S. Pat. No. 6,912,097 titled “Iris Diaphragm” and U.S. Patent Application Publication No. 20190111795A1 titled “Charge Port Assembly with Motorized Iris Door” by Rhodes, both of which are hereby incorporated by reference in their entireties. In further contemplated embodiments, an iris door may be used to further size restrict entry so as to filter the animal types that are able to insert their heads through opening 101a. The iris door may also, in some embodiments, be used to maintain the position of the animal's head, restrict its exit, and/or constrict around the animal's neck so as to asphyxiate, or strangle the predator. The CPU 351 may instruct one or more motors to which it is communicatively coupled to perform one or more of these functions. In further contemplated embodiments, an iris door may be placed in or adjacent to the front outer wall and/or the first interior wall (in some embodiments, in between the front outer wall and the first interior wall).

FIG. 3b depicts a front view of the moveable gate 108 which may comprise bars, mesh or size restrictive elements. The size restrictive elements may further comprise metals, woods, plastics, glass, ceramics and the like. Moveable gate 108 may be repositioned by means including but not limited to cables, pulleys, internally rotating cables, gears, pinions, pistons, hydraulics, gas driven slides, magnets, and moveable screws. A drive element 323 of a pulley system (with pulleys 322a and 322b) is shown attached to the top moveable gate 108. Upon meeting the preprogrammed facial recognition requirements, the CPU 351 and/or motor 356, such as servo unit 355, may be used to apply a force to moveable gate 108 to allow the selected predator's head entrance past front outer wall 101 and past first interior wall 106 into the head-operating-space between first interior wall 106 and second interior wall 107. For purposes of this disclosure, a “gate” should be considered to comprise any structure that can be used to open and/or close an opening, fully or partially, to allow for selective receipt of a predator head or another anatomical feature through the opening.

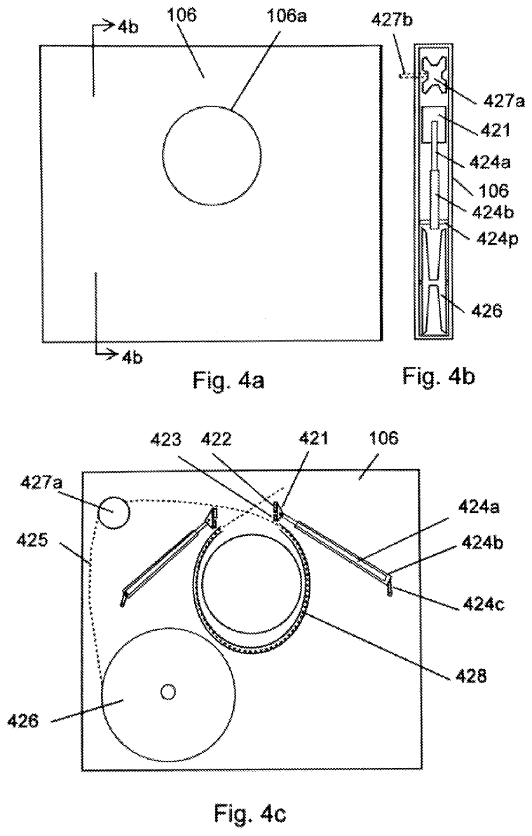

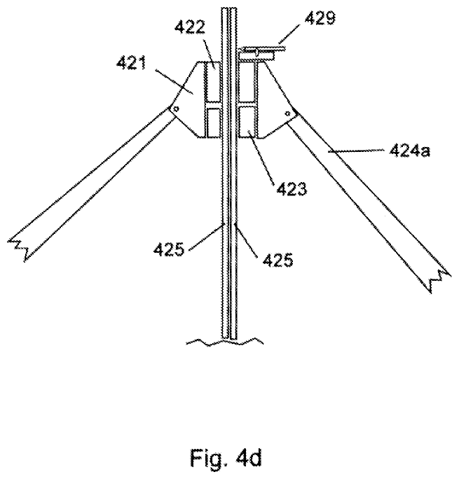

FIG. 4a depicts a front view of the first interior wall 106. In this embodiment, first interior wall 106 in concert with front outer wall 101 may partly or fully enclose the moveable gate, not seen in this view. In some embodiments, first interior wall 106 may be solid.

FIG. 4b depicts a side see through/transparent view of a hollow first interior wall containing a neck-collaring-means. FIGS. 4b, 4c, and 4d depict a neck-collaring-means, which may comprise a pivotable head 421, gripping element 422, which may comprise, for example, a rubber or silicone material configured to engage a polymer line 425 to, as described below, encircle a predator's neck to ultimately position the intersection of the polymer line 425 in place about the predator's neck for locking by another device. In some embodiments, an ultrasonic welder 423 (for plastic) may be used to lock the polymer line 425 about the predator's neck once it has been sufficiently tightened by gripping element 422. One or more piston arms 424a, piston base (pneumatic or hydraulic) 424b, and piston fastener/pivot 424p may be provided in order to supply the actuating force to gripping elements 422. In some embodiments, polymer line 425 may comprise a polypropylene material, such as a 50-100 pound test line, or another sonic-weldable material may be used for polymer line 425. Alternatively, a non-polymer material may be used in some contemplated embodiments, but may require a crimping or tying process rather than a welding process. Preferably, a relatively rigid material is used for polymer line 425 such that, as described below, the line may extend about opening 106a along a track or the Ike, such as the inwardly opened track described below, without collapsing through opening 106a.

Polymer line 425 may be stored on a main spool 426 and may pass around a second spool 427a, which may be motorized to allow the polymer line 425 to be pulled and guided into a storage position for subsequent use following a previous engagement about a predator's neck, as described in greater detail below. In some embodiments, the motorized spool 427a may be actuated via Bowden cable portion 427b.

Polymer line 425 may be guided by tracks onto main neck collaring semicircular track 428 whereupon it encircles opening 106a in the first interior wall 106. Once a command is given by the CPU, a pneumatic/compressed gas distributor may release gas from a gas tank via line 424c to actuate the pistons and thereby actuate grippers 422 against each other, thereby compressing and pushing up weldable polymer line 425 therebetween and drawing the circular portion of the line 425 up into opening 106a about the predator's neck. In some embodiments, a hydraulic distributor may be used to actuate grippers 422. At this point, line 425 may be sonically welded as opposing portions of sonic welders 423 make contact while sandwiching the polymer line 425. An actuatable blade 429 (see FIG. 4d) or other cutting means may be used to cut the line 425 above the sonic weld to allow the predator to be released and allow the line 425 to be advanced to receive a subsequent predator. In some embodiments, the cutting means may melt the plastic to cut it via electrical resistance by creating high thermal energy. Tension at the sonic weld of 5 pounds or greater may reduce breathing or blood flow thus compromising the predator's viability over time. Various actuators or other elements configured to provide the force to blade 429 may be used, such as the pistons 424a previously referenced, in order to drive blade 429 to sever line 425 following securement about a predator's head and/or retraction of blade 429 to await a subsequent predator head. Alternatively, as shown in the depicted embodiment and, more specifically, FIG. 4d, in some embodiments, blade 429 may be formed directly within or otherwise be operably coupled with head 421 and may be configured to extend and retract therewithin to selectively cut line 425 in between predator encounters. In some embodiments, blade 429 may be positioned on a track or the like to allow for such selective advancement and/or retraction. In some embodiments, blade 429 may be replaced with another suitable element configured to sever line 425, such as a thermal resistive element or the like.

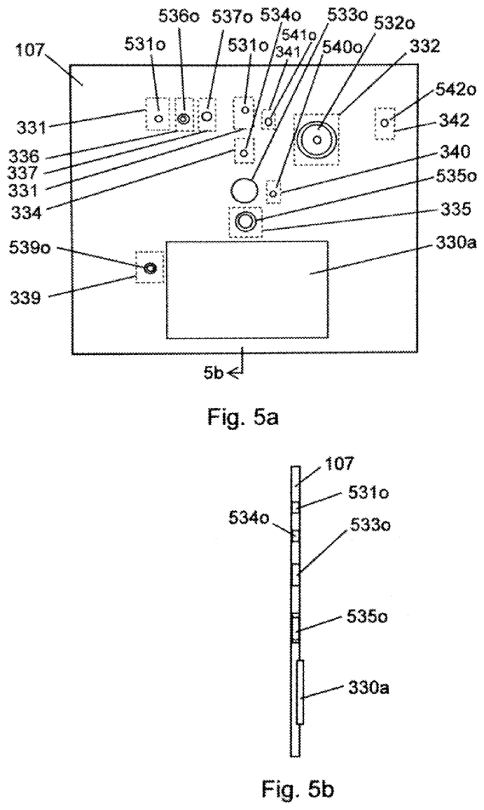

FIG. 5a depicts a front view of the second interior wall 107 which may comprise one or more camera opening(s) 531o, sounds-speaker opening 532o, food presentation opening 533o, vapor emitter opening 534o, jaw breaker opening 535o, eyeball probe opening 536o (for eyeball probe device/means), cornea toxic fluid/vapor emission opening 537o, ear-toxic fluid via vapor emission opening 542o, injection needle device/means opening 539o, lung-bound-gas emission device/means opening 540o and/or eye damaging LASER opening 541o. In some embodiments, a visual attractant 330a may be present on the second interior wall 107 such as a video or image on a LED, OLED or other screen and/or system for projecting images. In some embodiments, visual attractant 330a on the second interior wall 107 may serve other purposes, for example an OLED may be brightened to aid in facial or anatomical landmark (eye, nose, ear) recognition by brightening the intensity so the predator can see an object such as a food source in an enclosed area (interior lighting) or to be dimmed such that a pupil dilates allowing a LASER source to affect the retina.

In some embodiments, the openings may house all or part of each object of intended passage transiently (during movement or positioning) or permanently (if the object is fixed into the wall or the walls thickness allows). It is noteworthy that not all of the aforementioned holes/orifices be present and their respective mechanisms to terminate or disable the predator thus saving on costs and complexity. In addition, it should be understood that, whereas the mechanisms and/or detectors to which the aforementioned orifices are coupled may lie partly within the second interior wall 107 or principally within the instrumentation/storage space 114 between rear wall 102 and the second interior wall 107, it is also contemplated that some such mechanisms may be positioned solely within the space between the outer wall and the inner wall, which may negate the necessity for one or more of the aforementioned holes/orifices. Upon entry of a selected predator's head into head-operating-space 109 one or more of the aforementioned devices may act upon the head.

Complementing each reservoir when present as per the order of each various consumer is a distribution/action means which may be connected to various types of tubing or outlets to be transferred to each respective orifice. The aforementioned gas or liquid chemicals in reservoirs may be connected by hoses with interposed actuated syringes, pistons, gas/pneumatic pressure sources to prop& a portion of the desired liquid or gas at the intended target through the selected corresponding openings listed, A CPU may direct the actuated source of force to fire at a given portion of the target when a selected portion of the predator's anatomy appears to the camera and is interpreted favorably by the CPU and attendant software. For example, if a camera 531o located adjacent a camera, eyeball probe opening 536o (for eyeball probe device/means) or cornea toxic fluid/vapor emission opening 537o presents to the CPU a recognizable image of the predator's eye, in focus within an acceptable range of the probe or toxic emitter, then a signal to immediately fire may be given. Sighting for the probe may require more accuracy than for a fluid dispersion that may be of a wider angle. Some embodiments may be configured to simply fire or direct its injurious means to a single, target location, in which case the sensors/detectors, and/or CPU may be configured to simply actuate the injurious means upon detecting that the predator, or a desired feature of the predator, is within range and at the target location.

Alternatively, some embodiments may be configured to move the injurious means in response to detecting movement by the predator and/or a specific location for the predator head and/or a particular feature of the predator head. Thus, for example, some embodiments may be able to account for some movement by the predator head and move the injurious means accordingly to appropriately target the head or a specific feature of the head.

In some embodiments, as shown in FIG. 5a, one or more cameras 331 may be used, each of which may be positioned behind a corresponding camera opening 531o formed in a wall, such as wall 107, of the assembly. Cameras 331 in camera opening(s) 531o may be communicatively coupled with the CPU and may thereby transmit data to the CPU comprising a recognizable image of one or more features from the predator, such as the predator's face or component thereof, which may allow the CPU to, in turn, transmit a signal to a motor or actuating means to advance food via the food presentation opening 533o. In some contemplated embodiments, if the camera 331 presents a recognizable image to the CPU whilst the predator is in feeding position, a jaw breaking means 335 may be activated/dispatched via the jaw breaker opening 535o to fracture the predator's jaw.

Similarly, any of the other injurious elements may be communicatively coupled with the CPU such that, upon receipt of data from one or more of the aforementioned cameras 331 indicating that the predator, or a particular feature of the predator, is within range and/or in a desired position, a signal may be sent to the element to deliver the injurious element. Thus, an eyeball probe 336 may be positioned adjacent eyeball probe opening 536o, which may also, or alternatively, be coupled with the CPU to actuate eyeball probe 336 upon receiving a suitable indication that the predator's eye is in a desired position from one or more of the cameras 331.

Alternatively, or additionally, an atomizer 337 or any other pressurized fluid delivery device may be used to deliver a desired cornea toxic fluid via vapor emission opening 537o (again, preferably following detection of the predator's eye being in a suitable location, as mentioned above).

Alternatively, or additionally, an atomizer 342 or any other pressurized fluid delivery device may be used to deliver a desired ear-toxic fluid via vapor emission opening 542o, preferably following detection of the predator's ear being in a suitable location,

Alternatively, or additionally, an injection needle device/means 339 may be positioned adjacent to opening 5390 and, as mentioned, communicatively coupled with one or more cameras 331 and/or the CPU to deliver the needle at an appropriate time when the predator's neck or another desired target area is within range.

Alternatively, or additionally, an eye damaging LASER device/means 341 may be used to reduce sight in one or more eyes. Damaging one eye may be like the ear resulting in loss of stereoscopic vision and thus reduced ability to hunt prey successfully. Class 3B lasers are hazardous for eye exposure. For visible-light lasers, Class 3B lasers' output power is between 5 and 499 milliwatts. Many mammalian eyes are vulnerable to optical radiation at wavelengths between about 400 and 1,400 nanometers (in-band wavelength lasers). Blue and violet lasers >5 milliwatts may damage the retina. Lasers with wavelengths from 400 nm to around 1400 nm travel directly through the eye's lens, cornea and inter ocular fluid to reach the retina. In some embodiments, maximum absorption of laser energy onto the retina occurs in the range from 400-550 nm. Argon and YAG lasers operate in this range, making them the most hazardous lasers with respect to eye injuries. In further contemplated embodiments, far infrared (1400 nm to 1 mm; CO2 lasers, 10600 nm) yield thermal damage by heating the tears and tissue water of the cornea

Alternatively, or additionally, a lung-bound-gas emission device/means 340 may be positioned adjacent to opening 540o and, as mentioned, communicatively coupled with one or more cameras 331 and/or the CPU to deliver gas via opening 540o at an appropriate time, such as upon detecting the mere presence (precise locations may not be as important in this context) of the predator.

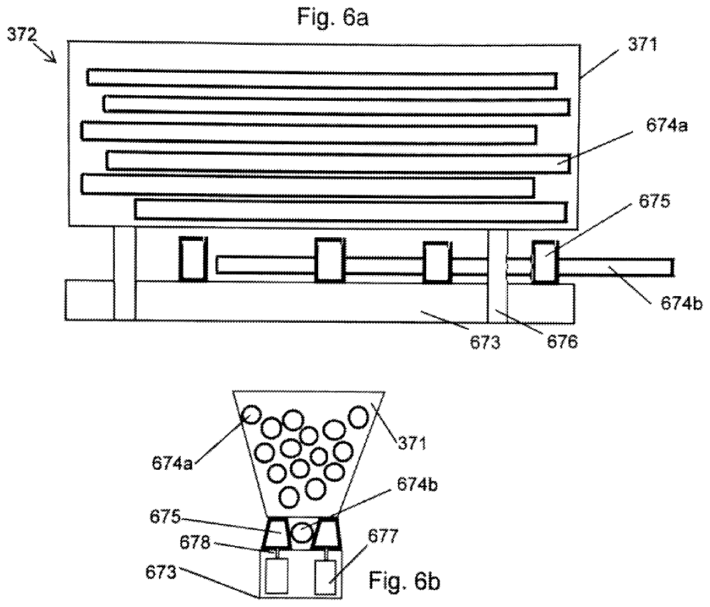

FIGS. 6a and 6b depict a large food source reservoir 371 and large food source distribution device/means 372. Stored food units 674a may be in the shape of solid round elongate tubes to facilitate relatively uniform movement gravitationally down the reservoir 371 and onto base/conveyor area 673. Supports 676 may be used to support the reservoir in relation to base/conveyor area 673. Food units 674a may be externally lubricious via, for example, oils, fats or waxes facilitating movement and discouraging unwanted sticking or attachment to one another and/or the reservoir wall. Loaded food unit 674b is moveable on base/conveyor area 673 by virtue of rotating pinch guides 675. Rotating pinch guides 675 may comprise metal with a frictionable or rasped surface. Alternatively, rotating pinch guides 675 may comprise a rubberized or gummy surface to grasp food units 674b. Rotating pinch guides 675 may be connected to drive shafts 678 which may be in turn connected to motors 677. Not all rotating pinch guides 675 need be driven by motors, especially those located furthest from the direction of forward motion. In some embodiments, the sides of rotating pinch guide 675 may be angled relative to their axis of rotation towards one another to form a wedge shape at the bottom, as shown in FIG. 6b, by virtue of, for example, their innate design or by the axis of fixation to drive shafts 678. This may aid in pinching effect or in gravitationally enhanced friction between the edges and the food thus helping to move the food when the torque of the motor creates torque at the surface/edge of a pinch guide 675. By rotating the two adjacent pinch guides 675 in opposite directions, they can engage a sausage or another suitable food unit 674a and advance it out of an opening, such as opening 533o, towards a predator. In some embodiments, a flap or door may be used to ensure that only a single food unit 674a enters base/conveyor area 673 at a time.

It should be understood that a wide variety of alternative embodiments will be apparent to those of ordinary skill in the art after having received the benefit of this disclosure. For example, the food distribution device/means may be configured to deliver food units externally of the device in some embodiments. It may be preferred, however, that such embodiments utilize an adjacent camera to allow for advancing food units only upon detecting a desired target predator.

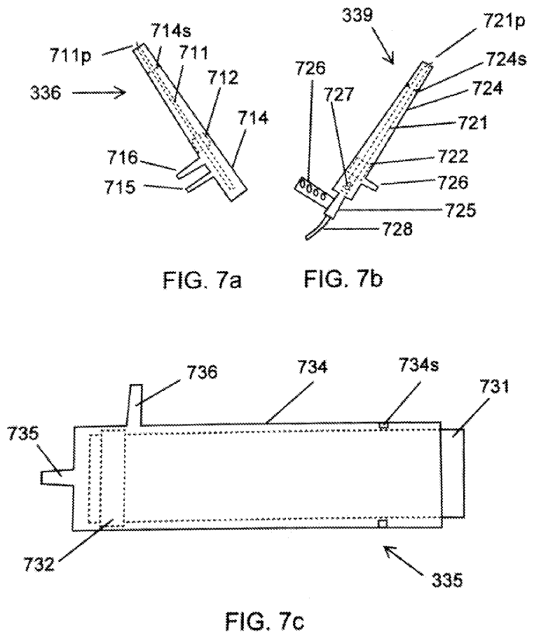

FIGS. 7a,b,c depict various examples of injurious elements. FIG. 7a depicts an embodiment of an eyeball probe device/means 336. Projectile 711 may have a sharp point 711p to assist penetration. An expanded area 712 around projectile 711 may facilitate gaseous pressure buildup that may further facilitate forward motion speed and force of the projectile. Expanded area 712 may be configured to contact one or more stops 714s in containment base 714. The containment base 714 of the probe holds the projectile 711 and is preferably configured to withstand the pneumatic pressure necessary to propel the projectile 711. Positive pneumatic pressure may be delivered to containment base 714 via inlet 715, which may be directly or indirectly attached to a hose/conduit, which may be, in turn, directly or indirectly attached to a compressed gas storage tank. Vacuum/negative pressure may be delivered to containment base 714 via inlet 716 which may be directly or indirectly attached to a hose/conduit, which may be, in turn, directly or indirectly attached to a vacuum storage tank. The vacuum in concert with expanded area 712 around projectile 711 may facilitate returning projectile 711 into position for further rounds of firing. In other contemplated embodiments, a spear gun like band may power/actuate the ejection and a motor and gear can reset the band for further use. The eyeball probe may be used to deliver an eye toxic chemical(s) and/or infectious microbes including but not limited to prions, viruses, bacteria and/or fungi to and/or into the eye.

FIG. 7b depicts an embodiment of an injection needle device/means 339. Hollow projectile needle 721 may have a sharp point 721p to assist penetration. A stopper 722 may be formed around needle 721 and may be movably positioned within the shaft containing needle 721 but fixedly coupled with needle 721. In addition, there may be an open region adjacent to the proximal end of the chamber containing stopper 722 and needle 721, which may allow for gaseous pressure buildup that may further facilitate forward motion speed and force of the needle 721, along with the stopper 722. In other words, pressure from the gas delivered via conduit 728 into inlet 725, which may be fluidly coupled both with the inner portion of needle 721 and with the surrounding chamber, within which stopper 722 is slidably positioned. Thus, following a first threshold pressure buildup, stopper 722 may be forced towards the distal end of the chamber, which forces needle 721 forward and into a suitable region of the predator, such as the predator's neck. Additional pressure buildup may be used to force a gel pellet 727, which may contain a poison, vaccine, sterilizing agent, and/or another injurious agent, through tip 721p of needle 721 and into the predator. In some implementations, a caplet (fluid contained by semisoft exterior), or semisoft caplet or hard pellet may be used instead of a gel pellet. In other implementations, venoms, some possibly crudely dried, kept in glass tubes with rubber stoppers, and stored at room temperature may be used.

Stopper 722 may be configured to contact one or more stops 724s in containment base/chamber 724. The containment base/chamber 724 may further be configured to receive needle 721 and to withstand the pneumatic pressure necessary to propel the needle 721. Positive pneumatic pressure may be delivered to containment base 724 via inlet 725, which may be directly or indirectly attached to hose/conduit 728, which may be directly or indirectly attached to a compressed gas storage tank. Vacuum/negative pressure may also be configured to be delivered to containment base 724 via port 726, which may also be directly or indirectly attached to a hose/conduit (not shown in figure) and which, in turn, may be directly or indirectly coupled to a vacuum storage tank. The vacuum in concert with stopper 722 around needle 721 may facilitate returning needle 721 into position for further rounds of firing.

In the depicted embodiment, gel/pellet magazine 726 may distribute gel pellet 727 containing a poison, vaccine, sterilizing agent and/or other deleterious agent into the inlet 725 which is fed positive pneumatic pressure via tube/conduit 728. The pellet 727 may be semi solid and meant to slightly jam inside the hollow needle 721, as shown in FIG. 7b, whereupon pressure further builds forcing the hollow needle 721 outward and, as mentioned above, after which additional pressure may further build to explosively expel pellet 727 from tip 721p.

FIG. 7c depicts an embodiment of a jaw breaker device/means 335. Jaw breaking core projectile 731 may be a solid metal to carry inertial force/kinetic energy. An expanded area 732 around core projectile 731 may facilitate gaseous pressure buildup that may further facilitate forward motion speed and force of the projectile. An expanded area 732 may be configured to contact one or more stops 734s in containment base 734. The containment base 734 of the probe holds the projectile 731 and is preferably configured to withstand the pneumatic pressure necessary to propel the projectile 731. Positive pneumatic pressure is delivered to containment base 734 via inlet 735 which may be directly or indirectly attached to a hose/conduit which may be directly or indirectly attached to the compressed gas storage tank. Vacuum/negative pressure is delivered to containment base 734 via inlet 736 which may be directly or indirectly attached to a hose/conduit which may be directly or indirectly attached to the vacuum storage tank. The vacuum in concert with expanded area 732 around core projectile 731 may facilitate returning core projectile 711 into position for further rounds of firing. The jaw breaker device/means is preferably oriented/pointed toward the mandibular jaw which will be positioned for optimal fracture during the eating process just below the food aperture. The jaw breaker device/means may also be actuated by spring or other mechanisms. The predator may not be able to adequately catch or consume sustenance with a broken mandible as healing may take weeks, yet the predators reserves may not last long enough.

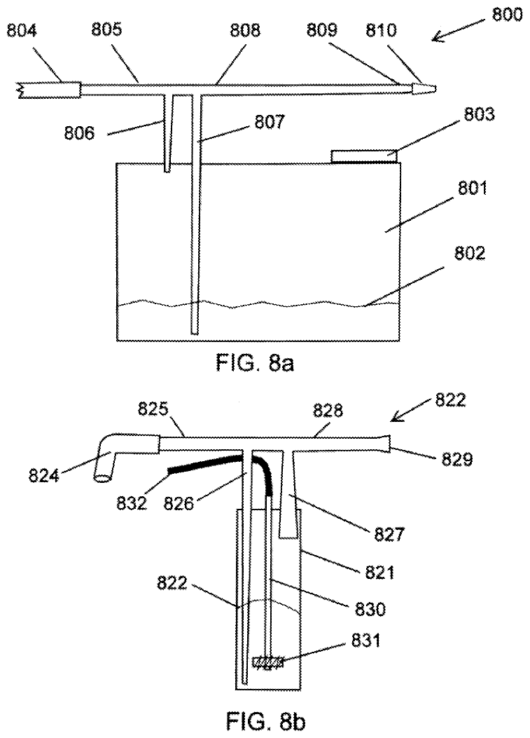

FIGS. 8a and 8b depict various liquid atomizers and powder sprayers. FIG. 8a depicts a liquid atomizer system 800 with reservoir 801 and fluid 802 contained therein. Main pre-reservoir tubing 805 may be connected to a pressurized gas source via conduit tubing 804. Main pre-reservoir tubing 805 is continuous with upper reservoir piercing gas outlet 806 as well as lower liquid level piercing liquid inlet 807 that allows for, upon receipt of pressure from gas delivered via gas outlet 806, receipt of rising liquid from reservoir 801 into main post-reservoir tubing 807, which leads to outlet area 809. Outlet area 809 may, in turn, be connected to an additional tip atomizer 810 if desired. Tip atomizers may suffice at the end of a fluid line as well to deliver sprays. Such tip atomizers may be screw cones atop a male screw fitted end with a loose enough space to allow air flow into the pressurized fluid stream in a lower pressure zone. A cap 803 may be used to selectively access reservoir 801.

FIG. 8b depicts a powder sprayer 822. Powder sprayer 822 comprises a reservoir 821 having powder 822 contained therein. Main pre-reservoir tubing 825 may be connected to a pressurized gas source via conduit tubing 824. Main pre-reservoir tubing 825 is continuous with powder piercing gas outlet 826 as well as reservoir inlet 827 that allows for, upon receipt of pressure from gas delivered via gas outlet 826, receipt of powder from reservoir 821 into tubing 827, which leads to outlet area 829. A cable 832, such as a Bowden cable, may be coupled with shaft 830 to deliver energy, such as a rotational force, to grinding tip 831, which may allow for breaking up the powder 822 and to disperse it into the upper portion of the chamber 821 and, ultimately, via pressure from gas outlet 826, into inlet 827 and out of outlet area 829.

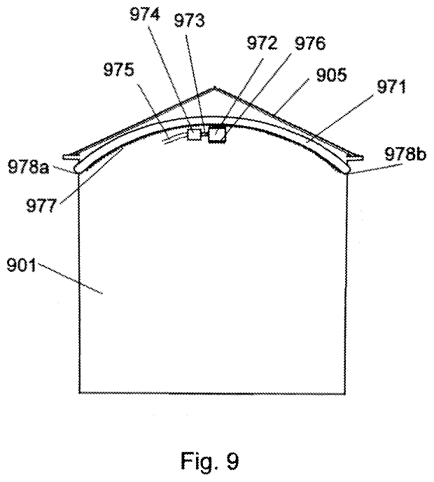

FIG. 9 depicts a feature that may be used in connection with any of the embodiments disclosed herein for repositioning the enclosure 901 in the event that it tips over. This feature is, in the depicted embodiment, provided by way of an elongated rod, tube, or other elongated member 971 that may be positioned within a corresponding tunnel and/or restraint/guide within the device and may be configured to selectively protrude from respective openings 978A and 978B on one or both ends of the tunnel. In some embodiments, this tunnel may be positioned adjacent to roof 905. A series of teeth 977 may be formed on elongated member 971, which may be engaged with a ratcheting system that may comprise a motor 974 electrically coupled with wires 975 or other electrical coupling means, a drive shaft 973, and a ratcheting member, such as a movable rack or band 972 comprising a set of teeth 976 configured to engage teeth 977 to move elongated member 971 in one direction or the other as needed. It should be noted that only one side of elongated member 971 may comprise teeth 977, which may allow the opposite side to smoothly move against a surface of the aforementioned tunnel. In other embodiments, other sides of the elongated member 971 may have teeth. In this embodiment the elongated member is curved and cross-sectionally round. In further embodiments, elongated member may be straight and of varying geometric cross sectional shapes.

To illustrate an example of operation of the feature shown in FIG. 9, assume the enclosure 901 were to be tipped over on its right side, which may be verified by one or more cameras or sensors. Motor 974 may then be actuated to push elongated member 971 out of opening 978b, which, in turn, will press against the ground and force enclosure 901 into its desired upright position.

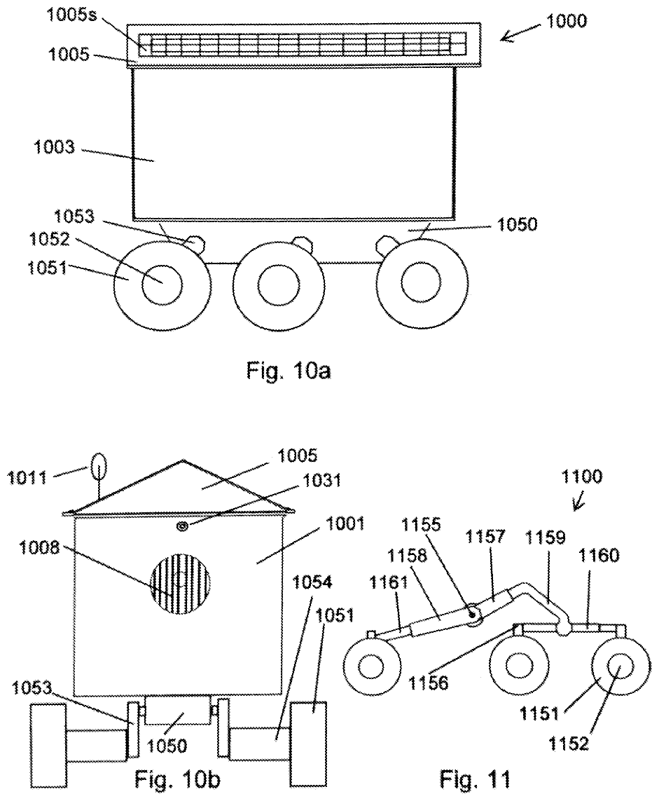

FIG. 10a depicts an alternative embodiment of a system 1000 that is configured to be mobile so as to allow for selective movement of the device to desired regions in which target predators may be more readily present. System 1000 comprises an enclosure 1003 that may be similar to any of the enclosures previously described. Enclosure 1003 may, for example, comprise any of the elements for attracting, detecting, temporarily capturing, sterilizing, injuring, or otherwise for preventing or limiting survival and/or reproduction described above. As previously mentioned, roof 1005 may comprise solar cells 1005s to allow for powering various elements in remote locations.

An undercarriage 1050 may be provided to which a plurality of wheels 1051 may be coupled so as to allow the device to be mobile. Each wheel 1051 may be coupled to undercarriage 1050 by way of an arm 1053 by way of a hub 1052. In some embodiments, this coupling may include springs or other shock absorbing elements to allow the device to travel over rough terrain. In some embodiments, springs or other shock absorbing elements may be present within undercarriage 1050 to prevent dust/dirt exposure.

FIG. 10b depicts a front view of system 1000. Thus, front wall 1001 may comprise an opening having a gate 1008 positioned therein, which, as previously mentioned, may be selectively actuatable to allow for drawing a predator head therein and capturing it for application of any of the various injurious means described herein. This figure further illustrates the presence of motors 1054, which may be coupled to each of the wheels 1051. In some embodiments, however, a single motor or a number of motors less than that of the wheels 1051 may be used. It is also contemplated that, in some embodiments, a cable, gear, or other drive system may be used with a single motor to distribute the energy to each of the wheels as desired. As those of ordinary skill in the art will appreciate, the device may be turned as desired by altering the distribution of forces to the wheels 1051, such as, for example, by applying a forward motion on one side and a reverse motion on the other side. One or more wheels, wheel hubs, wheel controllers may be hinged or coupled about various axes to alter mobility.

FIG. 11 depicts an alternative configuration for the wheels and/or drive system of another device 1100. As shown in this figure, in addition to wheels 1151, along with corresponding hubs 1152 and/or motors (not shown), one or more hinged arm assemblies may be provided. More particularly, a first arm 1159 may be coupled to a frame or undercarriage arm 1160 to which one or more of the wheels 1152 may be coupled via, for example, vertical arms 1156. Arm 1159 may be hingedly coupled to arm 1161 via a chassis fixation and pivot point 1155. Sleeves 1157 and 1158 may be provided and may extend in opposing directions from chassis fixation and pivot point 1155. Springs or other shock absorbing elements may be positioned within sleeves 1157 and/or 1158 to allow arms 1161 and 1159 to slide towards and away from one another to absorb impacts during movement of the device. One or more additional wheels 1151 may be positioned at the distal end of the hinged arm assembly depicted in FIG. 11.

As previously mentioned, one or more cameras may be used to detect a suitable predator and/or detect a desired position of a feature of the predator during use. However, such cameras, such as camera 1031 in FIG. 10b, may serve the additional purpose in the embodiments of FIGS. 10a-11 of allowing a user to view the current surroundings and view the terrain as the device is driven to a new location. In some embodiments, cameras in concert with terrain topography and directional programming either preprogrammed or by real-time cellphone or satellite uplink may be used to facilitate navigation of the enclosure to a new area.

An antenna, transceiver, or the like 1011 may also be used for multiple purposes. For example, antenna/transceiver 1011 may be used both to receive signals to operate various elements within the enclosure 1003 (or outside of the enclosure 1003), and may be used to receive a signal for driving the device to a desired location. Of course, signals may also be sent from antenna/transceiver 1011 for various purposes, such as sending images from camera 1031 to a remote operator.

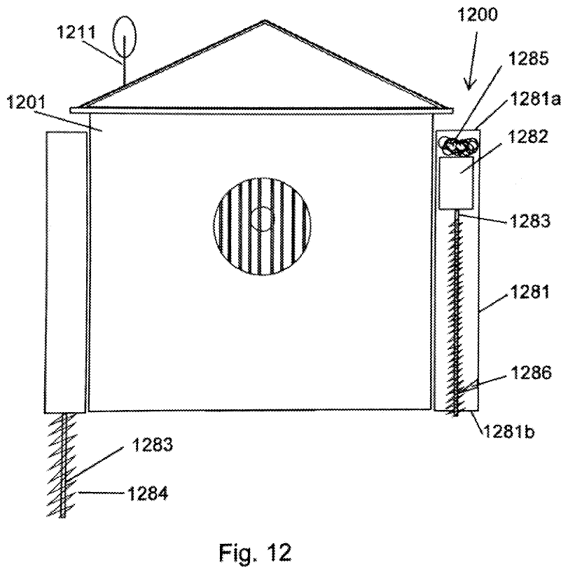

FIG. 12 depicts an example of yet another feature that may be used in connection with any of the embodiments disclosed herein. Assembly/system 1200 may allow an enclosure 1201 to be either manually or remotely mounted into the ground by, for example, a series of threaded shafts 1283 configured to be driven into the ground as needed. In the depicted embodiment, each of the corners of the assembly 1200 (or, in alternative embodiments, only a subset of the corners) may comprise a shaft 1283 with screw-like threads 1284, which may be positioned within a hollow tube 1281 for stability. For example, tube 1281 may be fixed to the corner of a wall of enclosure 1201. These tube(s) 1281 may have open upper ends 1281a to allow a user to insert a suitable driver or other instrument therein to manually stake the shafts 1283 into the ground. The bottom ends 1281b of tube(s) 1281 may also be open to allow for access to the ground beneath enclosure 1201. Alternatively, or additionally, one or more motors 1282 may be provided to allow for remote and/or automated driving of the shafts 1283. In some embodiments, coiled electrical wiring 1285 may sit atop motor 1282 uncoiling as the motor 1282 descends during entrenchment operation. In some embodiments, to prevent motor rotation, tube 1281 may be cross sectionally shaped in a non-circular fashion to match that of the motor to prevent turning. Alternatively, a linear vertical guide may be present in tube 1281 to match a slot in motor 1282. Remote operation may be facilitated by antenna/transceiver 1211. In some embodiments, a protrusion 1286 may project from the inner wall of tube 1281 to fit between or encounter screw-like threads 1284 to prevent components from falling through shaft/tube 1281. Protrusion 1286 may comprise, for example, a plastic and may, in some embodiments, be formed in a spatula-like shape positioned to scrape dirt from screw-like threads 1284 as the shaft and threads are retracted back into tube 1281 thus giving perhaps a partial cleaning.

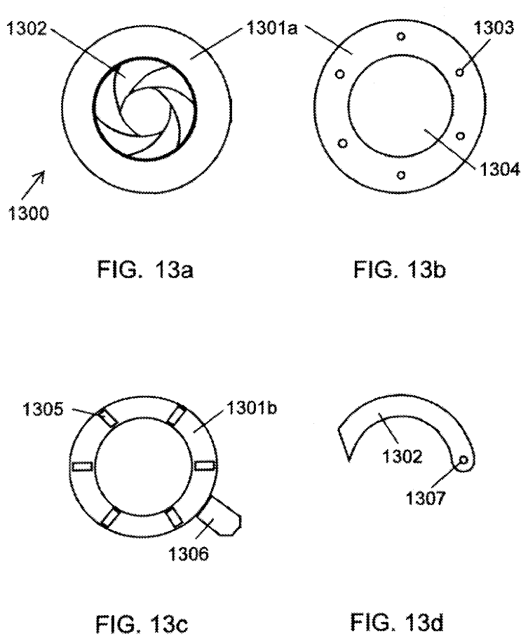

FIGS. 13a, 13b, 13c, and 13d depict an example of yet another feature that may be used in connection with any of the embodiments disclosed herein. Iris door/diaphragm assembly/system 1300 is an example of a size adjustable opening, and may allow for a modifiable opening in the front wall to allow for more specific, in some embodiments, real time, active predator selectivity and restriction. For example fox skulls often measure 130-165 mm, feral cats heads may measure 100+/−20 mm & ferrets much less. In the depicted embodiment, iris door/diaphragm assembly/system 1300 may comprise opposing ring halves 1301a and 1301b as well as vanes 1302. Vanes 1302 may moveably reduce the area of otherwise central void/space 1304. Vane pins 1307 may be fit through slots 1305 of opposing ring half 1301b into holes 1303 of the other opposing ring half 1301a. Movement of lever 1306 may move the vanes, thus altering the dimension of the otherwise central void/space 1304. In some embodiments, moveable lever 1306 may comprise an actuator, such as an air piston, a cable drive (including but not limited to push-pull or rotational), a motor, and/or other elements that may be used to open and close space/void 1304. The actuator may be communicatively coupled with the CPU and/or one or more sensors to allow for selectively opening and/or closing space/void 1304 upon detection of a desired predator, such as a fox or cat or ferret, and/or upon detection of the predator having removed its head from the adjacent opening of the front outer wall hole/aperture 101a located in front outer wall 101 of assembly 100. In some embodiments, a flexible shaft and/or cable assembly, such as a Bowden cable or push-pull cable, may be used to transmit motion from a motor to one or more portions of assembly 1300, such as opposing ring 1301b. Such actuators may be coupled to or used in place of various mechanical elements, such as, for example, universal joints, gears, sprockets and chains, and/or belts and pulleys.

In some embodiments, iris door/diaphragm assembly/system 1300 and central void/space 1304 may overlie one or more openings, such as opening 101a. This may allow for selective creation of an opening of a desired size to restrict various entrants, for example fox skulls often measure 130-165 mm thus restricting the opening to 120 mm may restrict out foxes while allowing cats & ferrets. This size alteration may be done in a permanent or relatively permanent manner or, alternatively, may be automated so as to specifically accommodate a particular predator that is detected in real time by one or more cameras and/or sensors of the assembly. The use of an iris diaphragm may allow for more specific real time active predator selectivity and restriction. An iris door/diaphragm should be considered an example of a size adjustable gate. It is to be appreciated by those of ordinary skill in the art of making iris openings that a varieties of vane shapes, pin and slot locations may be used to enable its use in an SPID system.

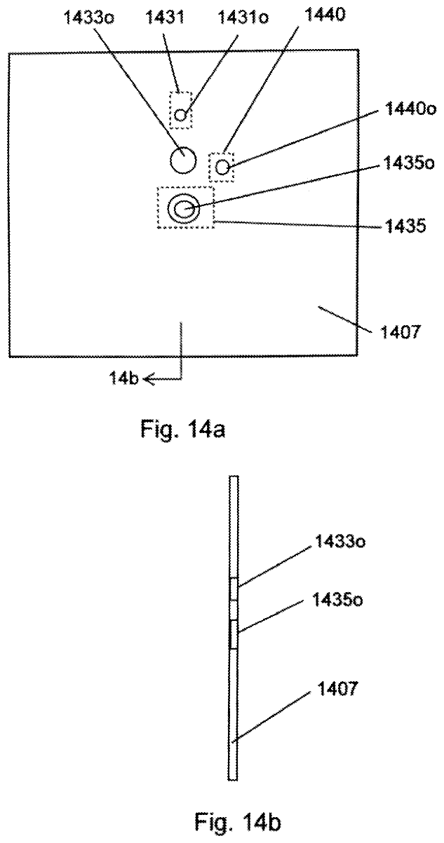

FIG. 14a depicts a front view of what was the second interior wall 1407 with the outer wall and first interior wall removed thus making the second interior wall into an outer wall. Thus the predator may be recognized outside of the enclosure and operated upon without entry. The second interior wall 1407 may comprise one or more camera opening(s) 1431o, food presentation opening 1433o, jaw breaker opening 1435o, lung-bound-gas emission device/means opening 1440o and/or any of the other predator detection, control, and/or incapacitation means disclosed herein Cameras 1431 may lie behind, adjacent to or in communication with camera opening(s) 1431o.

In some embodiments, the openings may house all or part of each object of intended passage transiently (during movement or positioning) or permanently (if the object is fixed into the wall or the walls thickness allows). It is noteworthy that not all of the aforementioned holes/orifices and/or their respective mechanisms need be present to terminate or disable the predator thus saving on costs and complexity. In addition, it should be understood that, whereas the mechanisms and/or detectors to which the aforementioned orifices are coupled may lie partly within the second interior wall 1407 or principally within the instrumentation/storage space 114 between rear wall 102 and the second interior wall 107.

Complementing each reservoir when present as per the order or of each various consumer is a distribution/action means which may be connected to various types of tubing or outlets to be transferred to each respective orifice.

Similarly, any of the other injurious elements may be communicatively coupled with the CPU such that, upon receipt of data from one or more of the aforementioned cameras 1431 indicating that the predator, or a particular feature of the predator, is within range and/or in a desired position, a signal may be sent to the element to deliver the injurious element. Thus, lung-bound-gas emission device/means 1440 may be positioned adjacent to opening 1440o and, as mentioned, communicatively coupled with one or more cameras 1431 and/or the CPU to deliver gas via opening 1440o at an appropriate time. Other items such as food presentation mechanism may lie behind, adjacent to or communicating with opening 1433o. Jaw breaker mechanism 1435 may lie behind, adjacent to or in communication with jaw breaker opening 1435o, for example.

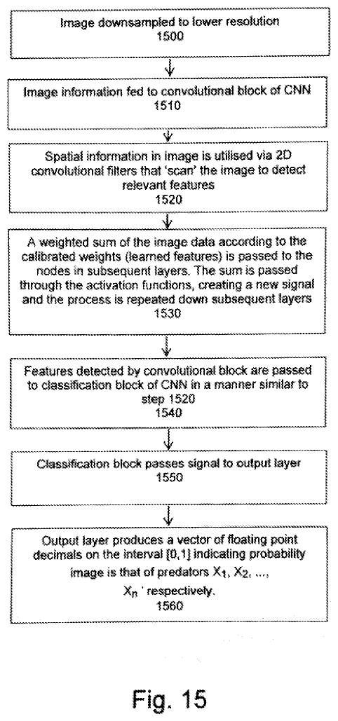

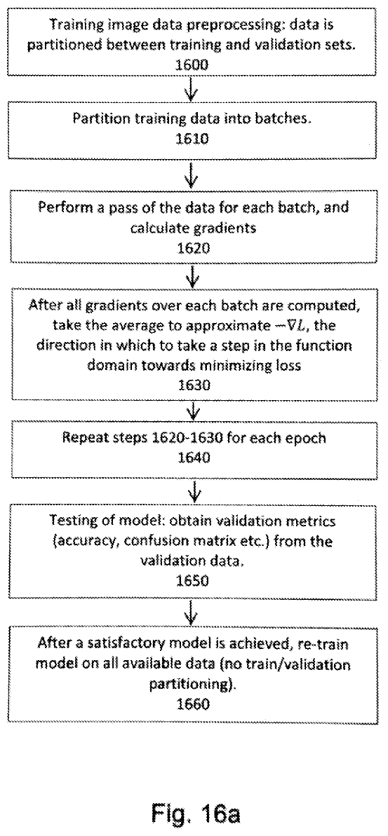

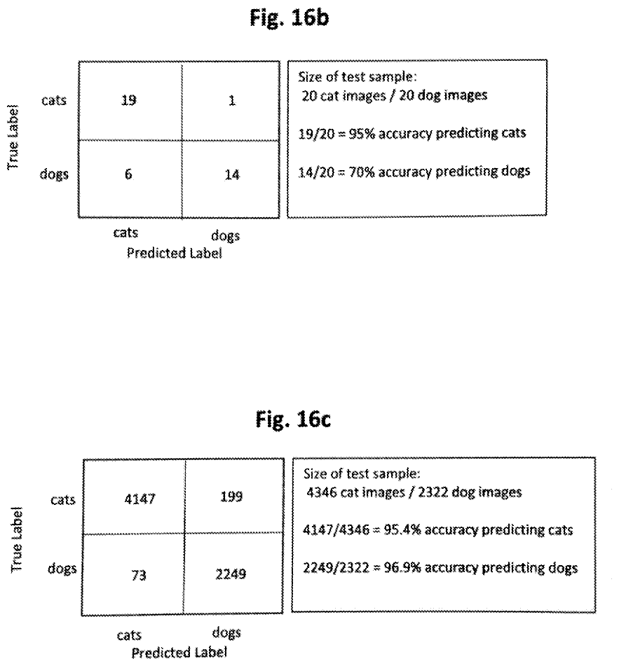

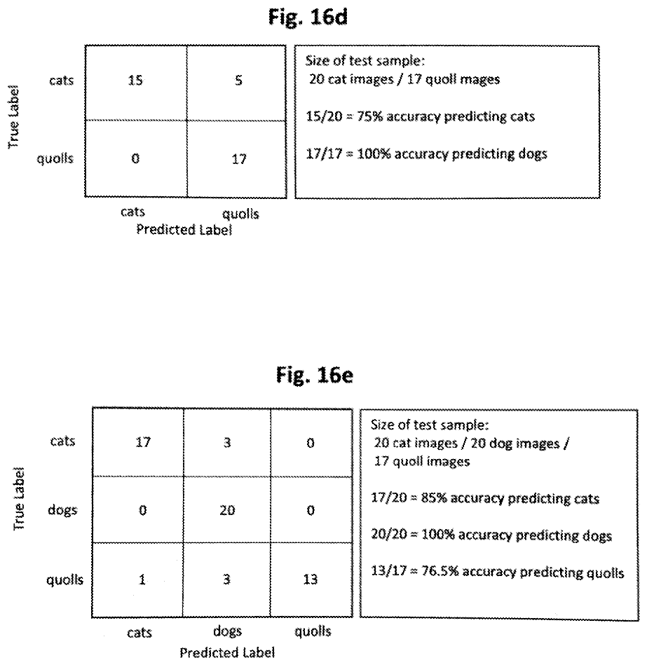

FIGS. 15, 16 depict an automated system for the identification of feral predator and/or invasive species using potential predator facial recognition software to restrict entry to the SPID system. Depending on the implementation, the input signal will be comprised of image data that will be taken by a CCD camera as a still photograph or a frame from a video (sequence of images). The identification mechanism is based on a Convolutional Neural Network (CNN) algorithm which allows the system to identify predators based on large volumes of existing image data. The system is intended to operate independently of human input, although in some implementations there is room for final human review, depending on the intended outcome of positive identification of predator species. The architecture of the identification mechanism may be updated and improved upon with additional image data in order to improve its identification capabilities.

This section outlines the function and implementation details of certain preferred system components and their relation to one another. The system's functionality is largely based on supervised machine learning (ML) models. These are models that may be ‘trained’ to solve problems without the need for the developer to directly or explicitly code a set of instructions to do so (R. Tibshirani, J. Friedman et al. 2001, The Elements of Statistical Learning, p. 2). ML models allow for great flexibility in adapting them to different scenarios, something desirable in the context of the intended use of preferred embodiments of the system. At high level, an ML image classifier ‘learns’ by adapting or tuning its parameters to a set of labelled training images, with the idea being that the model will be able to classify previously unseen images using these tuned parameters. When an image set that was not used to train the model is used to evaluate the prediction capabilities of the model, these images are referred to as the testing/test images. A function with sufficiently many degrees of freedom can be made to pass N data points exactly. In other words, a ML model is inherently prone to the danger of over-fitting—namely, fitting the model too closely to its training set and not performing as accurately on new images. Hence, it only makes sense to evaluate predictive capability on test images.

The following is a general description of the ML model architecture according to certain embodiments and implementations which comprises the overall predator recognition algorithm. It should be noted that when it comes to implementation of the ML model, certain parameters and architectural design aspects are variable and may thus be specified as required to meet the particular scope of its intended use. As such, the details of the model as subsequently described may generalize in a way to be used in a wide range of scenarios (G. James, D. W. T. Hastie et al., 2013, An Introduction to Statistical Learning with Applications in R., p. 1). Python offers several open-source machine learning libraries such as TensorFlow or PyTorch which allow for the easy implementation of the entirety of the model as described in this document.

FIG. 15 describes the process taken by a trained network to classify an image of a potential predator. Sites like Kaggle provide datasets of cats and dogs under a Public Domain license (“Cat and dog,” [Online]. Available: https://www.kaggle.com/tongpython/cat-and-dog) ((“Cat dataset,” [Online]. Available: https://www.kaggle.com/crawford/cat-dataset#)). Images may also be sourced via search engines. Where sizeable data sets for other animals may be difficult to obtain, a long-term solution may be to use “camera traps” installed in various locations to photograph species in the vicinity, for later manual classification by humans (M. S. Norouzzadeh, A. Nguyen et al. 2018, Automatically identifying, counting, and describing wild animals in camera-trap images with deep learning, Proceedings of the National Academy of Sciences of the United States of America, p. 1-2), These data can be used to train the model, taking into account all the relevant species. The model may take inputs of a fixed size (in this case, image resolution). To account for this, the input image may be downscaled to a lower resolution (e.g. 200×200), as in step 1500.

In step 1510, the input data may be fed forward to the convolutional block of the CNN, which may be comprised of a series of alternating convolution-pooling layers. The convolution layers are sensitive to features that correspond to the predator of interest, while the pooling layers ensure a degree of location invariance (G. James, D. W. T. Hastie et al., year, An Introduction to Statistical Learning with Applications in R., journal, p. 415); that is, the predator can be photographed from up close or at a distance or at different spots in the frame and the model should pick up its features regardless. Given below is an example of a model as described thus far.

```
def build_model_large(input_shape = (200,200)):
model = keras.Sequential(
    [
      # feature extraction block
      # block 1
      keras.layers.Conv2D(32, kernel_size = (3,3), activation = ‘relu’,
            kernel_initializer = ‘he_uniform’,
            input_shape = input_shape, padding = ‘same’),
      keras.layers.MaxPooling2D(pool_size = (2,2)),
      keras.layers.Dropout(0.2),
      # block 2
      keras.layers.Conv2D(64, kernel_size = (3,3), activation =‘relu’,
            kernel_initializer = ‘he_uniform’,
            padding = ‘same’),
      keras.layers.MaxPooling2D(pool_size = (2,2)),
      keras.layers.Dropout(0.2),
      # block 3
      keras.layers.Conv2D(128, kernel_size = (3,3), activation = ‘relu’,
            kernel_initializer = ‘he_uniform’),
      keras.layers.MaxPooling2D(pool_size = (2,2)),
      keras.layers.Dropout(0.2),
      # classification block
      keras.layers.Flatten( ),
      keras.layers.Dense(256, activation = ‘relu’,
            kernel_initializer = ‘he_uniform’),
      keras.layers.Dropout(0.5),
      keras.layers.Dense(1, activation = ‘sigmoid’) # outputs are cat or dog for now
      ]
    )
    opt = keras.optimizers.SGD(learning_rate = 0.0008, momentum = 0.8)
  model.compile(loss = “binary__crossentropy”, optimizer = opt, metrics = “accuracy”)
  reutrn model
```

Most of the computational burden in training the network lies in the convolutional block, owing to the large volumes of data and required network depth to achieve good classification accuracy. Thus, some implementations may take a transfer learning approach. This is the process of taking a pre-trained network (e.g. VGG16 (K. Simonyan and A. Zisserman, 2015, Very Deep Convolutional Networks for Large-Scale Image Recognition, ICLR)) and using its convolutional block to serve as the feature extractor part of the network. The opensource Keras API provides an implementation of VGG16 and documentation, along with many other nets (“Keras API reference/Keras Applications/VGG16 and VGG19,” [Online]. Available: https://keras.io/api/applications/vgg/#vgg16-function. [Accessed 31 August 2021]). Given below is the implementation of a VGG16-derived model.

```
def build_transfermodel(input_shape = (224,224, 3)):
  model = keras.applications.VGG16(include_top = False, weights = “imagenet”
                input_shape = input_shape)
  # freeze the feature extraction layers
  for layer in model.layers:
    layer.trainable = False
  # create custom classification layer and connect to VGG16
  x1 = keras.layers.Flatten( )(model.layers[−1].output)
  x2 = keras.layers.Dense(128,
activation=‘relu’,kernel_initializer=‘he_uniform’)(x1)
  # x3 = keras.layers.Dropout(0.5)(x2)
  output = keras.layers.Dense(1, activation=‘sigmoid’)(x2)
    # create the new model
  model = keras.models.Model(inputs=model.inputs, outputs=output)
    # compile model
  opt = keras.optimizers.SGD(learning_rate = 0.001, momentum = 0.85)
  model.compile(loss = “binary__crossentropy”, optimizer = opt,
metrics = “accuracy”)
  return model
```

The signals generated by the convolutional block may be passed forward to the classification block of the network, as in step 1540. The classification may comprise one or more densely connected layers which learn to associate the detected features as belonging to or not belonging the predator or predators in question (G. James, D, W. T. Hastie et al., year, An Introduction to Statistical Learning with Applications in R., journal, p. 416), as in step 1550. In step 1560, the output layer may produce a vector of values on the interval [0,1] which indicate the degree of confidence the network has classified the image. As an example, if the network is a binary classification model trained on dogs and cats, the output for an input image may be something like [0.92145, 0.07932], where the first entry represents the confidence the animal is a cat and the second represents the confidence the animal is a dog.

The following examples illustrate how the model in certain implementations and embodiments improves in its predictive capability as a function of training data size. The prediction may result in a testing set for a cat/dog recognition model trained on a small data set. An example of such a data set (42 images) is shown in FIG. 16b. The data in FIG. 16b depicts predicted versus true instances of cat/dog classification for a model trained on 42 images but tested on 40 different images. Note that accurate predictions lie within the upper left and lower right quadrants in a diagonal manner (19 & 14), and inaccurate predictions within the diagonal comprising the upper right and lower left quadrants (6 & 1). For example, the top right entry indicates that 1 cat was incorrectly predicted as a dog in this small sample.

This figure shows that, even on a small training data set, the model does fairly well in recognizing cats (95% accuracy) and somewhat reasonably on dogs, with 70% accuracy.

In other words, 30% of dogs in this sample are mistakenly classified as cats, which are, falsely identified as a desired target predator in our context. Increasing the volume of training data should in theory result higher accuracy and conversely, lower the rate of misclassification. When the training set was drastically increased, a marked increase in the predictive capability of the predictive capability was observed (95.4%, 96.9% accuracy for cats and dogs, respectively), as seen in FIG. 16c.

FIG. 16c depicts the results of predicted versus true instances of cat/dog classification for a model trained on 26736 images but tested on 6668 different images. Note that accurate predictions lie within the diagonal defined by the top left and lower right quadrants (4147 & 2249), and inaccurate predictions within the diagonal defined by the top right and lower left quadrants (73 & 199). For example, the top right entry indicates that 199 cats were incorrectly predicted as dogs in this larger sample.

Consider the quoll, a species of marsupial native to Australia. Despite being a marsupial, it is also referred to as the “native cat”. When the model was trained on a similar sized data set comprised of cat and quoll images, in the plot of FIG. 16d, we observe similar classification accuracies as in the small training size dog/cat scenario (75% and 100% accuracy on cats and quolls, respectively).

The plot of FIG. 16d depicts predicted versus true instances of cat/quoll classification for a mod& trained on 45 images but tested on 37 different images. Note that accurate predictions lie within the diagonal defined by the upper left and lower right quadrants (15 & 17), and inaccurate predictions within the diagonal defined by the upper right and lower left quadrants (0 & 5). For example, the top right entry indicates that 5 cats were incorrectly predicted as quolls in this small sample.

Thus, similar to the large cat/dog training set scenario, the model may end up greatly improving its cat/quoll predictive capabilities when the training set size is increased. Note that the model can generalize to learning the features of n different animals. Such a model for n=3 is illustrated in FIG. 16e, which depicts a plot trained on 76 images, containing roughly equal parts dog, cat and quoll images.

FIG. 16e depicts the results of predicted versus true instances of cat/dog/quoll classification for a multi-class model trained on 76 images but tested on 57 different images. Note that accurate predictions lie within the diagonal defined from the upper left portion of the graph to the lower right portion of the graph (17, 20 & 13), and inaccurate predictions in the remaining entries. For example, the bottom left entry indicates that 1 quoll was incorrectly predicted as a cat in this small sample.

Note that such a small training image set was used due to the limited quoll data available (when training the model, there should ideally be a roughly equal number of images for each class). In cases of insufficient data, it may be possible to apply the same concepts discussed in this document to distinguish animals via classification of individual features, e.g. nose, eyes, ears and others. Even with such a small training set, however, reasonable to adequate predictive capabilities can be observed in this test sample. Similar to the cat/dog case, we may therefore expect a substantial increase in the predictive capability with a great increase in training data.

Besides the previously mentioned work of Norouzzadeh et al., other research has been done on the application of Convolutional Neural Networks for multi-class animal classification, One example is that of a deep CNN based on ImageNet for generic and fine-grain classification of animals, e.g. dog: greyhound (Divya Meena, S., & Agilandeeswari, L., 2019, An Efficient Framework for Animal Breeds Classification Using Semi-Supervised Learning and Multi-Part Convolutional Neural Network (MP-CNN), IEEE Access). Work by Gomez et al. produced a multi-animal classification CNN to distinguish animals from low-quality images (Gomez, Alexander, Diez, German, Salazar, Augusto, & Diaz, Angelica, 2016, Animal Identification in Low Quality Camera-Trap Images Using Very Deep Convolutional Neural Networks and Confidence Thresholds, Advances in Visual Computing, 10072, 747-756). Other examples of deep CNN multi-class animal classifiers include the following: (Hung Nguyen, Sarah J. Maclagan et al., 2017, Animal Recognition and Identification with Deep Convolutional Neural Networksfor Automated Wildlife Monitoring, IEEE International Conference on Data Science and Advanced Analytics) and (Manohar, N, Kumar, Y. H. Sharath, Rani, Radhika, & Kumar, G. Hemantha., 2019. Convolutional Neural Network with SVM for Classification of Animal Images, Emerging Research in Electronics, Computer Science and Technology, 545, 527-537).

The following describes a model training process according to certain embodiments and implementations, as laid out in FIG. 16 and the particulars of the mechanics involved in the CNN architecture. The pre-processing stage may, in some implementations, involve first partitioning the image data set into training and validation sets (proportions usually range between 0.8 and 0.9 in favor of the training set), as in step 1600. The images may then be then read into memory and downsampled to the specified size in preparation to be fed into the network for training. In some implementations, it is possible to train the model without reading all the images into memory, though it is a slower process. Downsampling to as low as 200×200 pixels has shown to be practical.

Each individual pixel of the downsampled image may contribute to the total input signal for the CNN. The key feature of a CNN is the presence of convolutional filters, which examine 2D patches of pixels in an attempt to learn and later detect image features, which is the point illustrated in step 1520 in which spatial information in the image is utilized via convolutional filters to scan the image to detect and/or extract certain relevant features from the image. The model parameters may consist of ‘weights’ that connect the nodes of the network. The nodes may take input signals and transform them by means of, for example, ‘activation functions’ which are intended to allow the network to transform signals in order to pick up non-linear features, as described in step 1530. The network may thus take an input signal and pass it forward, transforming it between layers by means of the activation functions. The output layer that classifies the image may therefore be a function of one or more (in some cases, all) of the parameters in the preceding layers. The model thereby learns to ‘recognize’ features by comparing the predicted labels to the true, known labels from the training set using a so-called ‘loss function’.

In some implementations that involve transfer learning (i.e., incorporating a pre-trained model), the convolution block in the pre-trained network may be used for the model convolutional block. The parameters originally belonging to the pre-trained may be held constant during the training process. In this manner, the previously learned features may be adapted to the new dataset, and, in one particular example, the number of parameters needing to be trained may be dropped from approximately 18 million to only 3 million. Given below is a table summarizing the architecture of a VGG16-derived CNN which produced 98% testing accuracy.

| Layer (type) | Output Shape | Param # |
|---|---|---|
| input_1 (InputLayer) | [(None, 224, 224, 3)] | 0 |
| block1_conv1 (Conv2D) | (None, 224, 224, 64) | 1792 |
| block1_conv2 (Conv2D) | (None, 224, 224, 64) | 36928 |
| block1_pool (MaxPooling2D) | (None, 112, 112, 64) | 0 |
| block1_conv1 (Conv2D) | (None, 112, 112, 128) | 73856 |
| block2_conv2 (Conv2D) | (None, 112, 112, 128) | 147584 |
| block2_pool (MaxPooling2D) | (None, 56, 56, 128) | 0 |
| block3_conv1 (Conv2D) | (None, 56, 56, 256) | 295168 |
| block3_conv2 (Conv2D) | (None, 56, 56, 256) | 590080 |
| block3_conv3 (Conv2D) | (None, 56, 56, 256) | 590080 |
| block3_pool (MaxPooling2D) | (None, 28, 28, 256) | 0 |
| block4_conv1 (Conv2D) | (None, 28, 28, 512) | 1180160 |
| block4_conv2 (Conv2D) | (None, 28, 28, 512) | 2359808 |
| block4_conv3 (Conv2D) | (None, 28, 28, 512) | 2359808 |
| block4_pool (MaxPooling2D) | (None, 14, 14, 512) | 0 |
| block5_conv1 (Conv2D) | (None, 14, 14, 512) | 2359808 |
| block5_conv2 (Conv2D) | (None, 14, 14, 512) | 2359808 |
| block5_conv3 (Conv2D) | (None, 14, 14, 512) | 2359808 |
| block5_pool (MaxPooling2D) | (None, 7, 7, 512) | 0 |
| flatten (Flatten) | (None, 25088) | 0 |
| dense (Dense) | (None, 128) | 3211392 |
| dense_1 (Dense) | (None, 1) | 129 |

Total params: 17,926,209
Trainable params: 3,211,521
Non-trainable params: 14,714,688

In this model's case, the loss function may be binary or categorical cross-entropy, or some minor modification to these. Specifically, the mod& may be trained to minimize the overall loss on the training data, after which in principal the model may be able to make useful predictions on previously unseen images. It achieves this using ideas based on classical gradient descent. In particular, the so-called ‘backpropagation’ algorithm may be used to estimate the derivatives needed for gradient descent, Note that backpropagation, while the achieving the same outcome, does so in subtly different ways depending on the particular implementation or version.

In most applications, it is computationally infeasible to utilize all the training data at once when estimating gradients due to the sheer volume of data and parameters involved. Thus, stochastic optimizers may be used to traverse the loss function space in search of a local optimum in an approximate manner. Note that, due to the randomness introduced by the stochastic nature of the algorithm, along with the random initialization of weights, small variability may be introduced to all outputs. As indicated in steps 1610-1630, this may be done by doing gradient descent on many smaller batches, of the training data and then averaging. This is then repeated for the desired number of epochs, as indicated at step 1640. Below is a portion of code illustrating the training process.

```
datagen = keras.preprocessing.image.ImageDataGenerator(featurewise_center=True)
datagen.mean = [Rbar, Gbar, Bbar]
batch_size = 64
iterTrain = datagen.flow_from_directory(pathData+‘train/’, class_mode = ‘binary’,
                batch_size = batch_size, target_size = imgSize)
iterTest = datagen.flow_from_directory(pathData+‘test/’, class_mode = ‘binary’,
                batch_size = batch_size, target_size = imgSize)
# --------------------------------
# Generate and train model
# --------------------------------
model = build_transfermodel(input_shape = imgSize + (3,)) # using RGB channels
# model.summary( )
epochs = 1
history = model.fit_generator(iterTrain, steps_per_epoch = len(iterTrain),
        validation_data=iterTest,validation_steps=len(iterTest),
        epochs=epochs,verbose=1)
acc = model.evaluate_generator(iterTest, steps = len(iterTest), verbose = 1)
print(“Accuracy: {:.2f}%”.format(acc[1]*100))
```

Steps 1620-1630 describe the model calibration or model ‘learning’ process in which the loss gradient is approximated. The loss gradient gives information as to which model parameters should be adjusted to minimize loss, thereby improving model predictive capability. Step 1640 indicates that steps 1620-1630 form an iterative process and should be repeated until, for example, satisfactory loss is achieved, Note that the criterion for halting the iterations may be somewhat flexible. In most implementations, it may be most desirable to halt the training at the point where loss is minimized while also ensuring the overfilling has not occurred, After the model has been trained, its efficacy may be evaluated on the test set, as in step 1650. This may be done by predicting on the validation set initially set aside and assessing accuracy and loss. Once the model performs to satisfaction, the model can be re-trained on the entire dataset (step 1660), after which the model can be used as intended.

As those of ordinary skill in the art will appreciate, “facial recognition” may encompass any technique using any feature of an animal's face, such as the eye(s), nose, ear, mouth, etc., alone, or in combination with one or more other features of the face, in order to determine whether the animal is a desired predator within a given error probability.

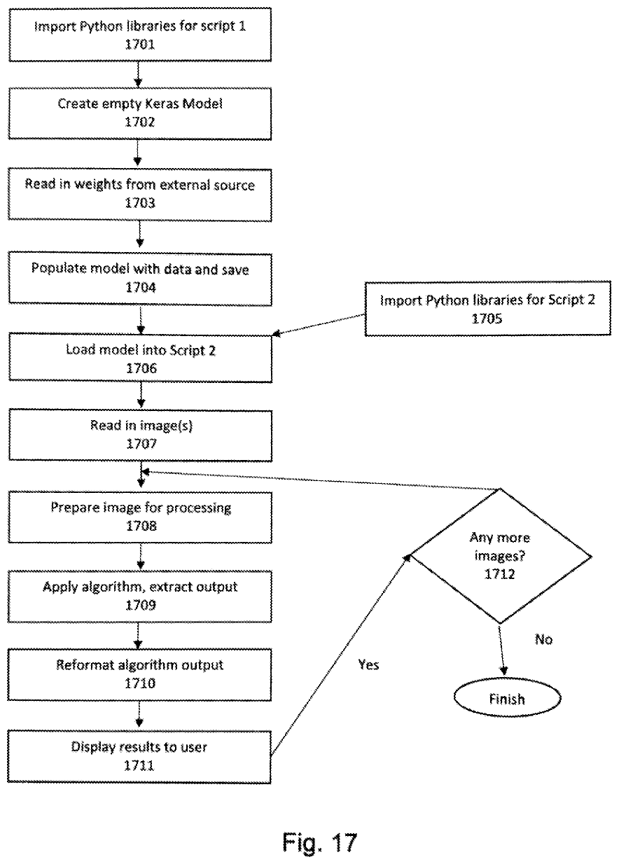

FIG. 17 is a flow chart depicting another example of a method 1700 for analyzing an image to detect whether it includes a desired predator, such as a cat.

Method 1700 is reliant on two scripts of computer code written in the Python language, These scripts are largely copies of open-source code by Jason Brownlee. https://machinelearningmastery.com/how-to-perform-object-detection-with-yolov3-in-keras/Script 1 prepares the algorithm and takes in the external data needed to make the predictions, corresponding to steps 1701 through 1704. Script 2 applies the algorithm to individual photos, corresponding to steps 1705 through 1711.

Script 1 starts with step 1701 which is the importing of a number of Python libraries, namely struct, numpy and parts of keras.layers and keras.models.

Once access to the functionality of these libraries has been obtained, method 1700 can proceed to step 1702. In this step, a function called make_yolov3_ model on line 160 of the script may create a Model object from the Keras library. This model, initially blank/empty may initially be put into a format that makes it possible to implement the 3rd version of You Only Look Once (YOLO) algorithm developed by Joseph Redmon et al. This algorithm, referred to as YOLOv3, is a commonly used and highly regarded algorithm for computer vision.

In step 1703, the external data source for the algorithm may be imported. This file yolov3.weights, was created by Redmon (https://pjreddie.com/darknet/yolo/), is 237 MB in size and contains data necessary for the detection of 80 common objects, including cats.

In step 1704, the external data is populated into the model with the Python

Class WeightReader on line 162, and the result of this may be saved (saved as a file with an extension “.h5” in the example). This file may, in some implementations, contain all the data and functionality necessary to implement the cat detection algorithm.

Script 2 may begin with step 1705 withthe loading of the Python libraries numpy and parts of keras.models, keras.preprocessing.image and matplotlib.

In step 1706, the function load_model on line 177 may load the previously saved .h5 file from step 1704 and makes it available for the script to use.

In step 1707, the image(s) to which the cat detection algorithm is being applied may be read in. The name(s) of the file(s) may be manually typed into or otherwise inserted/implemented into the script on line 181, such as a variable named photo_filenames.

Steps 1708-1711 may be applied separately to each image, in some implementations one-by-one. In step 1708, the image may be prepared to be processed by the algorithm by calling the function load_image_pixels on line 185. In some implementations of this step, the image may be resized to 416×416 pixels and converted to a table of numbers representing the colors in the original image, This standardized size may be helpful for the model to work with the given external data.

In step 1709, the algorithm may be applied. This may be achieved on line 187 of Script 2 with the command yhat=model.predict(image). The variable yhat contains the results of the algorithm in a raw form.

In step 1710, the information in yhat may be deciphered and reformatted in a format that is easier to use. At this point a threshold probability (class_threshold) may be specified. Only objects that the algorithm predicts to have a probability greater than this threshold of being genuine will be considered from here on. In this example, this parameter is set to 60%, but this can be adjusted as necessary to strike the right balance between false positives and false negatives, as desired by a manufacturer and/or end user of the system.

At that the end of this step, the system may have a list of potential objects, the probability that they are actually the object they are predicted to be, and the locations of the four corners of a rectangular box surrounding the potential object. In this step a change to the code (on line 171) originally provided by Brownlee was made. Any objects that are not predicted to be cats are ignored, saving considerable time and computational expense.

In step 1711, the person running the code may, in some implementations, see on the computer screen a copy of the image. Rectangular box(es) may, if desired, be overlaid around each potential cat detected. In some implementations, the name of the object (such as a cat) may be positioned and/or displayed above or otherwise adjacent to the box, potentially along with the probability that it is a cat or other target predator.

A key block of code, covering lines 183-219 of Script 2 is printed below. All functions referred to are defined earlier in the same file. In accordance with the syntax of Python, all lines beginning with a # are comments that are not executed by the computer. This code relates to steps 1708 through 1711.

```
for photo_filename in photo_filenames # STEP 1712:
# load and prepare image STEP 1708
image, image_w, image_h = load_image_pixels(photo_filename, (input_w, input_h))
  # make prediction STEP 1709
  yhat = model.predict(image)
  # summarize the shape of the list of arrays START OF STEP 1710
  print([a.shape for a in yhat])
  # define the anchors
anchors = [[116,90, 156,198, 373,326], [30,61, 62,45, 59,119], [10,13, 16,30, 33,23]]
  # define the probability threshold for detected objects
  class_threshold = 0.6
  boxes = list( )
  for i in range(len(yhat)):
    # decode the output of the network
boxes += decode_netout(yhat[i][0], anchors[i], class_threshold, input_h, input_w)
  # correct the sizes of the bounding boxes for the shape of the image
  correct_yolo_boxes(boxes, image_h, image_w, input_h, input_w)
  # suppress non-maximal boxes
  do_nms(boxes, 0.5)
  # define the labels
  labels = [List of 80 Objects omitted]
  # get the details of the detected objects [Line 213]
v_boxes, v_labels, v_scores = get_boxes(boxes, labels, class_threshold)
  # summarize what we found
  for i in range(len(v_boxes)):
    print(v_labels[i], v_scores[i])
  # draw what we found STEP 1711
draw_boxes(photo_filename, v_boxes, v_labels, v_scores)
```

In Step 1712, applied after steps 1708 through 1711 have been applied to each image, a determination may be made as to whether there are further images to process. If so, steps 1708 through 1711 may be applied to the next image. If not, the algorithm terminates.

Script 1 takes about thirty seconds on a modern laptop to run. This only needs to happen once on each device the cat detection algorithm is run on. Script 2 takes about thirty seconds initially, and a few seconds per image, Thus it is more efficient to apply the algorithm to batches of images, rather than a single image each time.

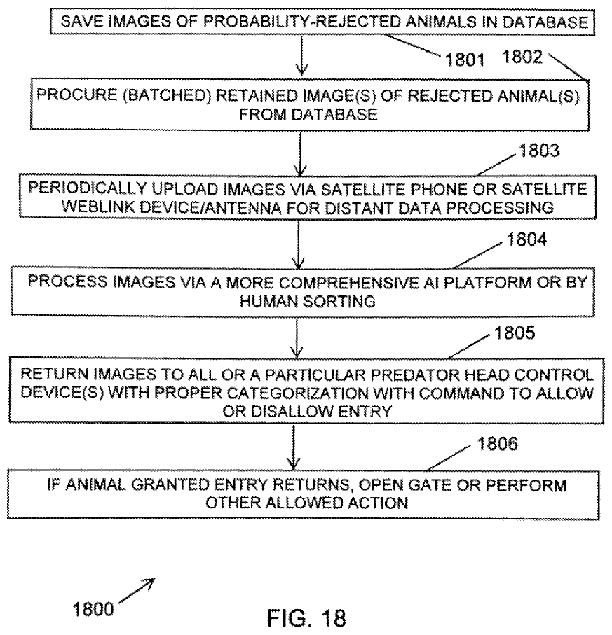

FIG. 18 depicts an example of a method for improving ability of a system to accurately assess the presence of a desired target predator in an image and actuate a gate or perform another desired action in response to a detection of a predator with sufficient precision according to some implementations and embodiments.

Method 1800 begins at step 1801, at which point various images of probability-rejected animals in database are saved, preferably along with an indication of their rejection by the system and/or a previous method.

In step 1802, retained image(s), such as batched images from a database, of rejected animal(s) may be procured or otherwise obtained from a database.

In step 1803, images may be uploaded, which may take place periodically on a set schedule or each time an image is accepted or rejected. This step may, in some implementations, be accomplished via a satellite connection, such as a satellite phone or satellite weblink device/antenna for distant data processing.

In step 1804, the uploaded images may be further processed, which may be accomplished via, for example, a more comprehensive Al platform or by human sorting. Preferably, this processing comprises further analysis of the images to determine whether a previous rejection of the images (or a previous acceptance of them in some cases) was proper.

In step 1805, these further processed images may be returned to a system, or to one or more particular predator incapacitations devices, with additional data from the further processing, For example, in some embodiments and implementations, such further processed images may be returned with data indicative of an updated/improved analysis as to whether they are accurately representative of a properly accepted or properly rejected photograph to accept or disallow entry. Preferably, only images and/or data sets that have been changed as a result of further processing/analysis will be returned/updated.

In step 1806, the updated results of this further processing may be implemented, Thus, for example, if/when an animal previously and incorrectly denied entry returns, a gate of an enclosure may be opened, or another desired action may be performed. Alternatively, step 1806 may simply comprise updating an Al system and/or database to allow the results of the further processing to be implemented, which need not include assessment of one of the same animals subject to the enhanced processing/analysis.

It should also be understood that some embodiments may comprise a system having a fleet of enclosures, each at a different location and each configured to generate data to improve the ability of the fleet to detect and reject animals as desired. Thus, for example, offsite processing may be used to improve the performance of an entire fleet of units rather than just one.

1. A predator incapacitation device, comprising:
an enclosure comprising an exterior opening;
a gate positioned within the exterior opening, wherein the gate is selectively openable to allow for receipt of a head of a predator therethrough; and
means for incapacitating the predator.

2. The predator incapacitation device of claim 1, wherein the enclosure comprises a roof comprising solar cells.

3. The predator incapacitation device of claim 1, further comprising an antenna for receiving wireless signals.

4. The predator incapacitation device of claim 3, wherein the antenna is operably coupled with the gate so as to allow the gate to be selectively opened remotely.

5. The predator incapacitation device of claim 1, further comprising a predator attractant.

6. The predator incapacitation device of claim 5, wherein the predator attractant comprises at least one of a speaker, a food delivery device, an airborne attractant, an attractant vapor emission device, and a visual attractant

7. The predator incapacitation device of claim 1, wherein the means for incapacitating the predator comprises at least one of a jaw breaker device, an eyeball probe, a cornea toxic fluid emission device, an eardrum-percussion device, an injection needle device, a gas emission device, an eye damaging LASER device, and an injection needle device.

8. The predator incapacitation device of claim 1, further comprising a camera positioned and configured to take images of an external environment adjacent to the enclosure.

9. The predator incapacitation device of claim 8, wherein the camera is operably coupled with the gate such that, upon detection of a predator with the camera, the gate is configured to open to allow the predator's head to extend into the enclosure through the exterior opening.

10. The predator incapacitation device of claim 9, wherein the predator head control device is configured to selectively open the gate only upon detection of a predetermined predator type.

11. The predator incapacitation device of claim 1, further comprising a neck collaring
means positioned adjacent to the gate, wherein the neck collaring means is configured to secure a line about the head of the predator after passing through the exterior opening.

12. A predator detection and incapacitation device, comprising:
an enclosure comprising an exterior opening;
an attractant configured to draw a predator towards the exterior opening;
a camera positioned and configured to take images of an external environment adjacent to the enclosure;
one or more processors configured to receive images from the camera;
an anatomical recognition module operably coupled with the camera and the one or more processors, wherein the anatomical recognition module is configured to use images from the camera to identify a likelihood that an animal adjacent to the enclosure is a selected predator; and
means for incapacitating the predator.

13. The predator detection and incapacitation device of claim 12, wherein the exterior opening is configured to receive a head of the predator therethrough.

14. The predator detection and incapacitation device of claim 12, further comprising a gate configured to selectively open the exterior opening.

15. A predator incapacitation device, comprising:
an enclosure comprising an exterior opening;
a gate configured to selectively open the exterior opening;
a camera positioned and configured to take images of an external environment adjacent to the enclosure;
one or more processors configured to receive images from the camera; and
an anatomical recognition module operably coupled with the camera and the one or more processors, wherein the anatomical recognition module is configured to use images from the camera to selectively actuate the gate to open the exterior opening.

16. The predator incapacitation device of claim 15, wherein the anatomical recognition module is configured to selectively actuate the gate upon detecting a specific species of predator.

17. The predator incapacitation device of claim 16, wherein the anatomical recognition module is configured to selectively actuate the gate upon detecting at least one of a fox, a cat, and a ferret.

18. The predator incapacitation device of claim 15, wherein the anatomical recognition module comprises a facial recognition module.

19. The predator incapacitation device of claim 18, wherein the facial recognition module is configured to use facial features comprising at least one of eyes, nose, and ears of an animal to create a matching profile for selective actuation of the gate.

20. The predator incapacitation device of claim 19, wherein the facial recognition module is configured to selectively actuate the gate upon detecting a matching profile that exceeds a threshold matching value.
